(19) United States
(12) Patent Application Publication
(10) Pub. No.: US 2024/0216864 A1
(43) Pub. Date: Jul. 4, 2024

(54) A CATALYST FOR THE SELECTIVE CATALYTIC REDUCTION OF NOX AND FOR THE CRACKING AND CONVERSION OF A HYDROCARBON

(71) Applicant: BASF Corporation, Florham Park, NJ (US)

(72) Inventors: Robert Dorner, Hannover (DE); Jan Martin Becker, Hannover (DE); Joseph A Patchett, Iselin, NJ (US)

(73) Assignee: BASF Corporation, Florham Park, NJ (US)

(21) Appl. No.: 18/557,075

(22) PCT Filed: Apr. 27, 2022
(86) PCT No.: PCT/EP2022/061133

§ 371 Date: Oct. 25, 2023

(30) Foreign Application Priority Data
Apr. 28, 2021 (EP) 21170867.2

(51) Int. Cl. B01D 53/94; B01J 23/42; B01J 23/44; B01J 29/16; B01J 29/46; B01J 29/67; B01J 29/76; B01J 29/80; B01J 35/00; B01J 35/57; B01J 37/00; B01J 37/02; B01J 37/10; C10G 11/04; F01N 3/24

(52) U.S. Cl. CPC B01D 53/9418; B01D 53/9472; B01D 53/9477; B01J 23/42; B01J 23/44; B01J 29/166; B01J 29/46; B01J 29/67; B01J 29/7615; B01J 29/763; B01J 29/80; B01J 35/19; B01J 35/57; B01J 37/0009; B01J 37/0201; B01J 37/0246; B01J 37/0248; B01J 37/10; C10G 11/04; F01N 3/24; B01D 2255/1021; B01D 2255/1023; B01D 2255/20738; B01D 2255/20761; B01D 2255/502; B01D 2255/504; B01D 2255/9032; B01D 2257/404; B01D 2258/012; B01J 2229/18

(57) ABSTRACT

The present invention relates to a catalyst for the selective catalytic reduction of NOx and for the cracking and conversion of a hydrocarbon, comprising a substrate comprising an inlet end, an outlet end, a substrate axial length extending from the inlet end to the outlet end and a plurality of passages defined by internal walls of the substrate extending therethrough: a coating disposed on the surface of the internal walls of the substrate, said coating comprising a platinum group metal, an 8-membered ring pore zeolitic material comprising one or more of copper and iron, and further comprising a 10- or more membered ring pore zeolitic material.

The present invention relates to a catalyst for the selective catalytic reduction of NOx and for the cracking and conversion of a hydrocarbon, and an exhaust gas treatment system comprising said catalyst and a downstream second catalyst. Further, the present invention relates to a process for preparing the catalyst, the use of said catalyst and said system as well as a method for simultaneously converting NOx and HC. Furthermore, the present invention relates to a catalyst for the selective catalytic reduction of NOx, for the ammonia oxidation and for the cracking and conversion of a hydrocarbon and an exhaust gas treatment system comprising said catalyst.

WO 2018/224651 A2 relates to an exhaust gas treatment system comprising a first catalyst for the abatement of HC and NOx comprising palladium and Cu-zeolitic material followed by a second catalyst downstream thereof comprising a NOx reduction component and an ammonia oxidation component.

U.S. Pat. No. 10,589,261 B2 discloses an exhaust system having a first zone containing a first SCR catalyst and a second zone containing an ammonia slip catalyst (ASC), where the ammonia slip catalyst contains a second SCR catalyst and an oxidation catalyst, and the ASC has diesel oxidation catalyst (DOC) functionality, where the first zone is located on the inlet side of the substrate and the second zone is located in the outlet side of the substrate are disclosed.

Further, it is a known problem that close coupled selective catalytic reduction (SCR) catalysts based on copper containing zeolitic material having a framework structure of the type CHA, may be sulfated with time even though there is no upstream oxidation catalyst due to the sulfur trioxide (SO₃) exiting from engine and internally generated by SCR catalysts. Here, the term “close coupled” catalyst is used herein to define a catalyst which is the first catalyst receiving the exhaust gas stream exiting from an engine. Accordingly, it results that close coupled SCR catalysts are not able to provide sufficient DeNOx to meet the Ultra-low nitrogen oxides (NOx) and nitrous oxide (N₂O) emissions, such as CARB after sulfation.

Therefore, it was an object of the present invention to provide a catalyst for the selective catalytic reduction of NOx and for the cracking and conversion of a hydrocarbon, which exhibits improved catalytic properties and which is able to fully recover after sulfation deactivation.

Surprisingly, it was found that the catalyst of the present invention for the selective catalytic reduction of NOx and for the cracking and conversion of a hydrocarbon exhibit improved catalytic properties and which are able to fully recover after sulfation deactivation.

Therefore, the present invention relates to a catalyst for the selective catalytic reduction of NOx and for the cracking and conversion of a hydrocarbon, comprising
(i) a substrate comprising an inlet end, an outlet end, a substrate axial length extending from the inlet end to the outlet end and a plurality of passages defined by internal walls of the substrate extending therethrough;
(ii) a coating disposed on the surface of the internal walls of the substrate, said coating comprising a platinum group metal, an 8-membered ring pore zeolitic material comprising one or more of copper and iron, and further comprising a 10- or more membered ring pore zeolitic material.

Preferably the platinum group metal comprised in the coating (ii) is selected from the group consisting of palladium, platinum, rhodium, iridium and osmium, more preferably selected from the group consisting of palladium, platinum and rhodium, more preferably selected from the group consisting of palladium and platinum. it is more preferred that the platinum group metal comprised in the coating (ii) is palladium.

Preferably the coating comprises the platinum group metal at a loading, calculated as elemental platinum group metal, in the range of from 2 to 100 g/ft³, more preferably in the range of from 5 to 80 g/ft³, more preferably in the range of from 7 to 60 g/ft³, more preferably in the range of from 8 to 40 g/ft³, more preferably in the range of from 10 to 30 g/ft³.

As to the coating (ii), it is preferred that it further comprises a non-zeolitic oxidic material comprising one or more of alumina, zirconia, silica, titania and ceria, more preferably one or more of alumina, zirconia and silica, more preferably one or more of alumina and zirconia, more preferably alumina or zirconia.

Preferably from 30 to 100 weight-%, more preferably from 50 to 99 weight-%, more preferably from 70 to 95 weight-%, more preferably from 80 to 92 weight-%, of the non-zeolitic oxidic material consist of zirconia. More preferably from 5 to 15 weight-%, more preferably from 6 to 12 weight-%, of the non-zeolitic oxidic material consist of lanthanum, calculated as La₂O₃.

Preferably the 8-membered ring pore zeolitic material comprised in the coating (ii) has a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI. More preferably the 8-membered ring pore zeolitic material comprised in the coating (ii) has a framework type CHA.

Preferably from 95 to 100 weight-%, more preferably from 98 to 100 weight-%, more preferably from 99 to 100 weight-%, more preferably from 99.5 to 100 weight-%, of the framework structure of the 8-membered ring pore zeolitic material consist of Si, Al, and O.

Preferably at most 1 weight-%, more preferably from 0 to 0.5 weight-%, more preferably from 0 to 0.1 weight-%, of the framework structure of the zeolitic material consist of P.

Preferably in the framework structure of the 8-membered ring pore zeolitic material, the molar ratio of Si to Al, calculated as molar SiO₂:Al₂O₃, is in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1. It is more preferred that, in the framework structure of the 8-membered ring pore zeolitic material, the molar ratio of Si to Al, calculated as molar SiO₂:Al₂O₃, is in the range of from in the range of from 15:1 to 20:1. Alternatively, it is more preferred that, in the framework structure of the 8-membered ring pore zeolitic material, the molar ratio of Si to Al, calculated as molar SiO₂:Al₂O₃, is in the range of from 25:1 to 33:1.

Preferably the 8-membered ring pore zeolitic material comprised in the coating (ii), more preferably having a framework type CHA, has a mean crystallite size of at least 0.1 micrometer, more preferably in the range of from 0.1 to 3.0 micrometers, more preferably in the range of from 0.3 to 1.5 micrometer, more preferably in the range of from 0.4 to 1.0 micrometer determined via scanning electron microscopy.

Preferably the coating (ii) comprises the zeolitic material at a loading in the range of from 0.1 to 3.0 g/in³, more preferably in the range of from 0.5 to 2.5 g/in³, more preferably in the range of from 0.7 to 2.2 g/in³, more preferably in the range of from 0.8 to 2.0 g/in³.

Preferably the 8-membered ring pore zeolitic material comprised in the coating (ii) comprises copper, wherein said coating comprises copper in an amount, calculated as CuO, being more preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, based on the weight of the 8-membered ring pore zeolitic material comprised in the coating (ii).

Preferably the 10- or more membered ring pore zeolitic material comprised in the coating (ii) is a zeolitic material having a framework type selected from the group consisting of FER, MFI, BEA, MWW, AFI, MOR, OFF, MFS, MTT, FAU, LTL, MEI, MOR, a mixture of two or more thereof and a mixed type of two or more thereof, more preferably selected from the group consisting of FAU, FER, MFI, BEA, MWW, MOR, a mixture of two or more thereof and a mixed type of two or more thereof, more preferably selected from the group consisting of FAU, FER, MFI, and BEA. More preferably the 10- or more, more preferably the 10- or 12-, membered ring pore zeolitic material is a zeolitic material having a framework type FAU or FER or MFI or BEA.

Preferably from 95 to 100 weight-%, more preferably from 98 to 100 weight-%, more preferably from 99 to 100 weight-%, more preferably from 99.5 to 100 weight-%, of the framework structure of the 10- or more membered ring pore zeolitic material consist of Si, Al, and O.

Preferably at most 1 weight-%, more preferably from 0 to 0.5 weight-%, more preferably from 0 to 0.1 weight-%, of the framework structure of the 10- or more membered ring pore zeolitic material consist of P.

Preferably in the framework structure of the 10- or more membered ring pore zeolitic material, the molar ratio of Si to Al, calculated as molar SiO₂:Al₂O₃, is in the range of from 2:1 to 60:1, more preferably in the range of from 3:1 to 40:1, more preferably in the range of from 3:1 to 35:1.

Preferably the 10- or more membered ring pore zeolitic material comprised in the coating (ii) is a zeolitic material having a framework type BEA, wherein, in the framework structure of said zeolitic material, the molar ratio of Si to Al, calculated as molar SiO₂:Al₂O₃, is in the range of from 4:1 to 20:1, more preferably in the range of from 6:1 to 15:1, more preferably in the range of from 8:1 to 12:1.

Alternatively, it is preferred that the 10- or more membered ring pore zeolitic material comprised in the coating (ii) is a zeolitic material having a framework type FER, wherein, in the framework structure of said zeolitic material, the molar ratio of Si to Al, calculated as molar SiO₂:Al₂O₃, is in the range of from 10:1 to 30:1, more preferably in the range of from 15:1 to 25:1, more preferably in the range of from 18:1 to 22:1.

Alternatively, it is preferred that the 10- or more membered ring pore zeolitic material comprised in the coating (ii) is a zeolitic material having a framework type FAU, wherein in the framework structure of said zeolitic material, the molar ratio of Si to Al, calculated as molar SiO₂:Al₂O₃, is in the range of from 3:1 to 15:1, more preferably in the range of from 4:1 to 10:1, more preferably in the range of from 4:1 to 8:1.

Alternatively, it is preferred that the 10- or more membered ring pore zeolitic material comprised in the coating (ii) is a zeolitic material having a framework type MFI, wherein in the framework structure of said zeolitic material, the molar ratio of Si to Al, calculated as molar SiO₂:Al₂O₃, is in the range of from 10:1 to 35:1, more preferably in the range of from 20:1 to 32:1, more preferably in the range of from 25:1 to 30:1.

In the context of the present invention, it is preferred that the 10- or more membered ring pore zeolitic material comprised in the coating (ii) comprises one or more of iron, copper and a rare earth element component, more preferably one or more of iron and a rare earth element component. Alternatively, it can be preferred that the 10- or more membered ring pore zeolitic material comprised in the coating (ii) be in its H-form.

It is more preferred that the coating (ii) comprises the one or more of iron, copper and a rare earth element component in an amount, calculated as the respective oxide, being preferably in the range of from 1 to 20 weight-%, more preferably in the range of from 5 to 20 weight-%, more preferably in the range of from 2 to 8 weight-%, or more preferably in the range of from 10 to 20 weight-%, based on the weight of the 10- or more membered ring pore zeolitic material comprised in the coating (ii).

Preferably said zeolitic material comprised in the coating (ii) comprises iron. It is preferred that, when the 10- or more membered ring pore zeolitic material comprised in the coating (ii) comprises iron, the coating (ii) comprises iron in an amount, calculated as Fe₂O₃, in the range of from 2 to 8 weight-%, more preferably in the range of from 2.5 to 6 weight-%, more preferably in the range of from 3 to 5.5 weight-%, based on the weight of the 10- or more membered ring pore zeolitic material comprised in the coating (ii).

It is alternatively preferred that said zeolitic material comprised in the coating (ii) comprises a rare earth element component. Preferably the rare earth element component comprises one or more of La, Ce, Pr, Nd, Pm, Sm, Eu, Gd, Tb, Er, Y and Yb, more preferably comprises one or more of La, Ce, Pr, Nd, Sm, Eu, Y, Yb and Gd, more preferably comprises one or more of La and Ce.

More preferably from 60 to 100 weight-%, more preferably from 80 to 100 weight-%, of the rare earth element component consist of La and/or Ce. In other words, it is preferred that, in the rare earth element component comprised in the coating (ii), La and/or Ce be the predominant element(s).

It is preferred that, when the 10- or more membered ring pore zeolitic material comprised in the coating (ii) comprises a rare earth element component, the coating (ii) comprises a rare earth element component in an amount, calculated as the respective oxide(s), in the range of from 10 to 20 weight-%, more preferably in the range of from 12 to 18 weight-%, more preferably in the range of from 14 to 17 weight-%, based on the weight of the 10- or more membered ring pore zeolitic material comprised in the coating (ii)

Preferably the coating (ii) extends over from 95 to 100%, more preferably from 98 to 100%, more preferably from 99 to 100%, of the substrate axial length.

It is preferred that the coating according to (ii) comprises, more preferably consists of,
(ii.1) an inlet coat comprising the platinum group metal and the 10- or more membered ring pore zeolitic material; and
(ii.2) an outlet coat comprising the platinum group metal, a non-zeolitic oxidic material, more preferably as defined in the foregoing, and the 8-membered ring pore zeolitic material comprising one or more of copper and iron;
wherein the inlet coat (ii.1) extends over x % of the substrate axial length from the inlet end towards the outlet end of the substrate according to (i), wherein x ranges from 20 to 80, more preferably from 30 to 60, and
wherein the outlet coat (ii.2) extends over y % of the substrate axial length from the outlet end towards the inlet end of the substrate according to (i), wherein y ranges from 20 to 80, more preferably from 30 to 60.

Preferably the inlet coat (ii.1) is disposed on the surface of the internal walls of the substrate (i), and preferably the outlet coat (ii.2) is disposed on the surface of the internal walls of the substrate (i), wherein y is 100−x.

It is preferred that the platinum group metal comprised in the inlet coat (ii.1) is supported on the 10- or more membered ring pore zeolitic material comprising one or more of iron, copper and a rare earth element component.

It is preferred that the platinum group metal in the inlet coat (ii.1) is palladium and that the 10- or more membered ring pore zeolitic material in the inlet coat (ii.1) is a zeolitic material having a framework type BEA, wherein said zeolitic material more preferably comprises one or more of iron, copper and a rare earth element component, more preferably one or more of iron and a rare earth element component, more preferably iron. It is alternatively preferred that the platinum group metal in the inlet coat (ii.1) is palladium and that the 10- or more membered ring pore zeolitic material in the inlet coat (ii.1) is a zeolitic material having a framework type FAU, wherein said zeolitic material more preferably comprises one or more of iron, copper and a rare earth element component, more preferably one or more of iron and a rare earth element component, more preferably a rare earth element component as defined in in the foregoing. It is alternatively preferred that the platinum group metal of the inlet coat (ii.1) is palladium and that the 10- or more membered ring pore zeolitic material in the inlet coat (ii.1) is a zeolitic material having a framework type MFI, wherein said zeolitic material more preferably comprises one or more of iron, copper and a rare earth element component, more preferably one or more of iron and a rare earth element component, more preferably iron.

In the context of the present invention, it is preferred that from 99 to 100 weight-%, more preferably from 99.5 to 100 weight-%, more preferably from 99.9 to 100 weight-%, of the inlet coat (ii.1) consists of the platinum group metal, the 10- or more membered ring pore zeolitic material and more preferably one or more of iron, copper and a rare earth element component.

It is preferred that the inlet coat (ii.1) further comprises a non-zeolitic oxidic material, more preferably as defined in the foregoing, wherein the platinum group metal comprised in the inlet coat (ii.1) is supported on said non-zeolitic oxidic material, wherein the inlet coat (ii.1) more preferably comprises the non-zeolitic oxidic material in an amount in the range of from 5 to 50 weight-%, more preferably in the range of from 10 to 50 weight-%, based on the weight of the inlet coat (ii.1).

It is preferred that the platinum group metal in the inlet coat (ii.1) is palladium, the non-zeolitic oxidic material comprises zirconia or alumina, and that the 10- or more membered ring pore zeolitic material in the inlet coat (ii.1) is a zeolitic material having a framework type BEA, wherein said zeolitic material more preferably comprises one or more of iron, copper and a rare earth element component, more preferably one or more of iron and a rare earth element component, more preferably iron. It is alternatively preferred that the zeolitic material having a framework type BEA be in its H-form.

Preferably from 99 to 100 weight-%, more preferably from 99.5 to 100 weight-%, more preferably from 99.9 to 100 weight-%, of the inlet coat (ii.1) consists of the platinum group metal, the non-zeolitic oxidic material, the 10- or more membered ring pore zeolitic material and optionally one or more of iron, copper and a rare earth element component.

Preferably the inlet coat (ii.1) comprises the platinum group metal at a loading, calculated as elemental platinum group metal, in the range of from 5 to 40 g/ft³, more preferably in the range of from 10 to 35 g/ft³, more preferably in the range of from 15 to 30 g/ft³.

Preferably the inlet coat (ii.1) comprises the zeolitic material at a loading in the range of from 1 to 2 g/in³, more preferably in the range of from 1.1 to 1.5 g/in³.

Preferably at most 0.1 weight-%, more preferably at most 0.01 weight-%, more preferably at most 0.001 weight-%, of the inlet coat (ii.1) consists of an 8-membered ring pore zeolitic material. In other words, it is preferred that the inlet coat (ii.1) is substantially free of, more preferably free of, an 8-membered ring pore zeolitic material.

Preferably the platinum group metal of the outlet coat (ii.2) is supported on the non-zeolitic oxidic material of the outlet coat (ii.2).

Preferably the outlet coat (ii.2) comprises the non-zeolitic oxidic material at a loading in the range of from 0.05 to 1 g/in³, more preferably in the range of from 0.1 to 0.5 g/in³.

Preferably the weight ratio of the 8-membered ring pore zeolitic material of the outlet coat (ii.2) relative to the non-zeolitic oxidic material of the outlet coat (ii.2) is in the range of from 3:1 to 20:1, more preferably in the range of from 5:1 to 15:1, more preferably in the range of from 8:1 to 12:1.

Preferably in the framework structure of the 8-membered ring pore zeolitic material of the outlet coat (ii.2), the molar ratio of Si to Al, calculated as molar SiO₂:Al₂O₃, is in the range of from 15:1 to 33:1, more preferably in the range of from 15:1 to 20:1, or more preferably in the range of from 25:1 to 33:1.

Preferably the 8-membered ring pore zeolitic material comprised in the outlet coat (ii.2) comprises copper, wherein said outlet coat (ii.2) comprises copper in an amount, calculated as CuO, being more preferably in the range of from 2.5 to 5.5 weight-%, more preferably in the range of from 2.75 to 5.5 weight-%, more preferably in the range of from 3 to 3.75 weight-%, or more preferably in the range of from 4.5 to 5.25 weight-%, based on the weight of the 8-membered ring pore zeolitic material comprised in the outlet coat (ii.2).

Preferably the platinum group metal in the outlet coat (ii.2) is palladium and the non-zeolitic oxidic material of the outlet coat (ii.2) comprises zirconia.

Preferably the outlet coat (ii.2) comprises the platinum group metal at a loading, calculated as the elemental platinum group metal, in the range of from 5 to 25 g/ft³, more preferably in the range of from 10 to 20 g/ft³.

Preferably the outlet coat (ii.2) comprises the 8-membered ring pore zeolitic material at a loading in the range of from 1 to 4 g/in³, more preferably in the range of from 1.5 to 2.5 g/in³.

Preferably the outlet coat (ii.2) further comprises a metal oxide binder, wherein the metal oxide binder more preferably comprises one or more of zirconia, alumina, titania, silica, and a mixed oxide comprising two or more of Zr, Al, Ti and Si, more preferably one or more of alumina and zirconia, more preferably zirconia.

It is preferred that the outlet coat (ii.2) comprises said metal oxide binder in an amount in the range of from 1 to 8 weight-%, more preferably in the range of from 3 to 7 weight-%, based on the weight of the 8-membered ring pore zeolitic material comprising one or more of copper and iron.

Preferably from 99 to 100 weight-%, more preferably from 99.5 to 100 weight-%, more preferably from 99.9 to 100 weight-%, of the outlet coat (ii.2) consists of the platinum group metal, the non-zeolitic oxidic material, the 8-membered ring pore zeolitic material comprising one or more of copper and iron, and more preferably a metal oxide binder as defined in the foregoing.

Preferably at most 0.1 weight-%, more preferably at most 0.01 weight-%, more preferably at most 0.001 weight-%, of the outlet coat (ii.2) consists of a 10- or more membered ring pore zeolitic material. In other words, it is preferred that the outlet coat (ii.2) is substantially free of, more preferably free of, a 10- or more membered ring pore zeolitic material.

It is alternatively preferred that the coating according to (ii) comprises, more preferably consists of,
(ii.1) an inlet coat comprising the 10- or more membered ring pore zeolitic material, wherein at at most 0.1 weight-%, more preferably at most 0.01 weight-%, more preferably at most 0.001 weight-%, of the inlet coat (ii.1) consist of a platinum group metal; and
(ii.2) an outlet coat comprising the platinum group metal, a non-zeolitic oxidic material, more preferably as defined in the foregoing, and the 8-membered ring pore zeolitic material comprising one or more of copper and iron;
wherein the inlet coat (ii.1) extends over x % of the substrate axial length from the inlet end towards the outlet end of the substrate according to (i), wherein x ranges from 20 to 80, more preferably from 30 to 60, and
wherein the outlet coat (ii.2) extends over y % of the substrate axial length from the outlet end towards the inlet end of the substrate according to (i), wherein y ranges from 20 to 80, more preferably from 30 to 60. As to the composition of the inlet coat, it is preferred in other words, that the inlet coat (ii.1) is substantially free of, more preferably free of, a platinum group metal.

It is alternatively preferred that the coating according to (ii) comprises, more preferably consists of,
(ii.1) an inlet coat comprising the platinum group metal and the 10- or more membered ring pore zeolitic material; and
(ii.2) an outlet coat comprising a non-zeolitic oxidic material, more preferably as defined in the foregoing, and the 8-membered ring pore zeolitic material comprising one or more of copper and iron;
wherein the inlet coat (ii.1) extends over x % of the substrate axial length from the inlet end towards the outlet end of the substrate according to (i), wherein x ranges from 20 to 80, more preferably from 30 to 60, and
wherein the outlet coat (ii.2) extends over y % of the substrate axial length from the outlet end towards the inlet end of the substrate according to (i), wherein y ranges from 20 to 80, more preferably from 30 to 60. As to the composition of the outlet coat, it is preferred in other words, that the outlet coat (ii.2) is substantially free of, more preferably free of, a platinum group metal.

In the context of the present invention, it is alternatively preferred that the coating (ii) be a single coat.

Preferably the non-zeolitic oxidic material of the coating (ii) comprises zirconia or alumina, wherein the coating (ii) more preferably comprises said non-zeolitic oxidic material at a loading in the range of from 0.05 to 1 g/in³, more preferably in the range of from 0.1 to 0.5 g/in³.

Preferably in the framework structure of the 8-membered ring pore zeolitic material of the coating (ii), the molar ratio of Si to Al, calculated as molar SiO₂:Al₂O₃, is more preferably in the range of from 15:1 to 20:1.

It is preferred that the 8-membered ring pore zeolitic material comprised in the coating (ii) comprises copper, wherein said coating comprises copper in an amount, calculated as CuO, being more preferably in the range of from 2.5 to 5.5 weight-%, more preferably in the range of from 4.5 to 5.25 weight-%, based on the weight of the 8-membered ring pore zeolitic material comprised in the coating (ii).

Preferably the weight ratio of the 8-membered ring pore zeolitic material of the coating (ii) relative to the non-zeolitic oxidic material of the coating (ii) is in the range of from 2:1 to 15:1, more preferably in the range of from 3:1 to 12:1, more preferably in the range of from 5:1 to 9:1.

Preferably the weight ratio of the 8-membered ring pore zeolitic material of the coating (ii) relative to the 10- or more membered ring pore zeolitic material of the coating (ii) is in the range of from 2:1 to 15:1, more preferably in the range of from 3:1 to 12:1, more preferably in the range of from 5:1 to 9:1.

It is preferred that the 8-membered ring pore zeolitic material of the coating (ii) has a framework type CHA and that the 10- or more membered ring pore zeolitic material of the coating (ii) has a framework type BEA and comprises iron.

It is alternatively preferred that the 8-membered ring pore zeolitic material of the coating (ii) has a framework type CHA and that the 10- or more membered ring pore zeolitic material of the coating (ii) has a framework type FAU and comprises a rare earth element component as defined in in the foregoing.

It is alternatively preferred that the 8-membered ring pore zeolitic material of the coating (ii) has a framework type CHA and that the 10- or more membered ring pore zeolitic material of the coating (ii) has a framework type MFI and comprises iron.

It is alternatively preferred that the 8-membered ring pore zeolitic material of the coating (ii) has a framework type CHA and that the 10- or more membered ring pore zeolitic material of the coating (ii) has a framework type FER.

It is preferred that the coating (ii) further comprises a metal oxide binder, wherein the metal oxide binder more preferably comprises one or more of zirconia, alumina, titania, silica, and a mixed oxide comprising two or more of Zr, Al, Ti and Si, more preferably one or more of alumina and zirconia, more preferably zirconia.

It is preferred that the coating (ii) preferably comprises a metal oxide binder at an amount in the range of from 1 to 8 weight-%, more preferably in the range of from 3 to 7 weight-%, based on the weight of the 8-membered ring pore zeolitic material comprising one or more of copper and iron.

Preferably from 99 to 100 weight-%, more preferably from 99.5 to 100 weight-%, more preferably from 99.9 to 100 weight-%, of the coating (ii) consists of the 10- or more membered ring pore zeolitic material, optionally comprising one or more of iron, copper and a rare earth element component, the platinum group metal, the 8-membered ring pore zeolitic material comprising one or more of copper and iron, more preferably a non-zeolitic oxidic material as defined in in the foregoing, and more preferably a metal oxide binder as defined in the foregoing.

It is preferred that the substrate (i) is a flow-through substrate or a wall-flow filter substrate, more preferably a flow-through substrate.

Preferably the flow-through substrate (i) comprises, more preferably consists of, a ceramic substance, wherein the ceramic substance more preferably comprises, more preferably consists of, one or more of an alumina, a silica, a silicate, an aluminosilicate, more preferably a cordierite or a mullite, an aluminotitanate, a silicon carbide, a zirconia, a magnesia, more preferably a spinel, and a titania, more preferably one or more of a silicon carbide and a cordierite, more preferably a cordierite. In the context of the present invention, it can be preferred that the catalyst of the present invention comprising a ceramic substrate be located downstream of an electrically heated device that is not coated/catalytically active in an exhaust gas treatment system.

Alternatively, it is preferred that the flow-through substrate (i) comprises, more preferably consists of, a metallic substance. With regard to the substrate of the catalyst comprising, more preferably consisting of, a metallic substrate, no specific restriction exits provided that the substrate is suitable for the intended use of the catalyst of the present invention. It is preferred that the metallic substance comprises, more preferably consists of, oxygen and one or more of iron, chromium and aluminum. More preferably the substrate is electrically heated.

It is preferred that the catalyst of the present invention consists of the substrate (i) and the coating (ii).

Furthermore, it was also an object of the present invention to provide an exhaust gas treatment system which permits the simultaneous selective catalytic reduction of NOx and the cracking and conversion of hydrocarbon, generating temperature though an exotherm, for desulfation. Surprisingly, it was found that the exhaust gas treatment system of the present invention permits the simultaneous selective catalytic reduction of NOx and the cracking and conversion of hydrocarbon, generating temperature though an exotherm, for desulfation.

Therefore, the present invention relates to an exhaust gas treatment system for treating an exhaust gas stream exiting a diesel engine, said exhaust gas treatment system having an upstream end for introducing said exhaust gas stream into said exhaust gas treatment system, wherein said exhaust gas treatment system comprises
(a) a first catalyst having an inlet end and an outlet end, wherein said catalyst is a catalyst according to the present invention;
(b) a second catalyst having an inlet end and an outlet end and comprising a coating disposed on a substrate, wherein the coating comprises a platinum group metal supported on a non-zeolitic oxidic material and further comprises one or more of a vanadium oxide, a tungsten oxide and a zeolitic material comprising one or more of copper and iron;
   wherein the first catalyst according to (a) is the first catalyst of the exhaust gas treatment system downstream of the upstream end of the exhaust gas treatment system and wherein the inlet end of the first catalyst is arranged upstream of the outlet end of the first catalyst;
   wherein in the exhaust gas treatment system, the second catalyst according to (b) is located downstream of the first catalyst according to (a) and wherein the inlet end of the second catalyst is arranged upstream of the outlet end of the second catalyst.

It is preferred that the outlet end of the first catalyst according to (a) is in fluid communication with the inlet end of the second catalyst according to (b) and that between the outlet end of the first catalyst according to (a) and the inlet end of the second catalyst according to (b), no catalyst for treating the exhaust gas stream exiting the first catalyst is located in the exhaust gas treatment system.

Preferably the platinum group metal of the coating of the second catalyst (b) is selected from the group consisting of platinum, palladium, rhodium, iridium and osmium, more preferably selected from the group consisting of platinum, palladium and rhodium, more preferably selected from the group consisting of platinum and palladium. It is more preferred that the platinum group metal of the second catalyst (b) is platinum.

Preferably the coating of the second catalyst (b) comprises the platinum group metal, preferably Pt, at a loading, calculated elemental platinum group metal, more preferably as elemental Pt, in the range of from 0.1 to 10 g/ft³, more preferably in the range of from 0.2 to 5 g/ft³, more preferably in the range of from 0.5 to 4 g/ft³, more preferably in the range of from 1 to 3 g/ft³.

It is preferred that the non-zeolitic oxidic material of the coating of the second catalyst (b) comprises one or more of titania, zirconia, silica, alumina and ceria, more preferably one or more of titania, zirconia and alumina, more preferably one or more of titania and zirconia, more preferably titania, wherein the coating of the second catalyst (b) comprises said non-zeolitic oxidic material at a loading in the range of from 0.05 to 1 g/in³, more preferably in the range of from 0.1 to 0.5 g/in³.

Preferably from 30 to 100 weight-%, more preferably from 50 to 99 weight-%, more preferably from 70 to 95 weight-%, more preferably from 80 to 92 weight-%, of the non-zeolitic oxidic material consist of titania. More preferably from 5 to 15 weight-%, more preferably from 6 to 12 weight-%, of the non-zeolitic oxidic material consist of silicon, calculated as SiO₂.

It is preferred that the coating of the second catalyst (b) comprises a zeolitic material having a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI. It is preferred that the zeolitic material of the coating of the second catalyst (b) has a framework type CHA.

Preferably from 95 to 100 weight-%, more preferably from 98 to 100 weight-%, more preferably from 99 to 100 weight-%, more preferably from 99.5 to 100 weight-%, of the framework structure of the zeolitic material of the coating of the second catalyst (b) consist of Si, Al, and O.

Preferably at most 1 weight-%, more preferably from 0 to 0.5 weight-%, more preferably from 0 to 0.1 weight-%, of the framework structure of said zeolitic material consist of P.

Preferably, in the framework structure of the zeolitic material of the coating of the second catalyst (b), the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1.

Preferably the zeolitic material of the coating of the second catalyst (b), more preferably having a framework type CHA, has a mean crystallite size of at least 0.1 micrometer, more preferably in the range of from 0.1 to 3.0 micrometers, more preferably in the range of from 0.3 to 1.5 micrometer, more preferably in the range of from 0.4 to 1.0 micrometer determined via scanning electron microscopy.

It is preferred that the coating of the second catalyst (b) comprises the zeolitic material at a loading in the range of from 1 to 6 g/in³, more preferably in the range of from 1.5 to 4 g/in³, more preferably in the range of from 2 to 3 g/in³.

Preferably the zeolitic material comprised in the coating of the second catalyst (b) comprises copper, wherein said coating comprises copper in an amount, calculated as CuO, being more preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, more preferably in the range of from 4.5 to 5.25 weight-%, based on the weight of the 8-membered ring pore zeolitic material comprised in the coating of the second catalyst (b).

It is preferred that the coating of the second catalyst (b) further comprises a metal oxide binder, wherein the metal oxide binder more preferably comprises one or more of zirconia, alumina, titania, silica, and a mixed oxide comprising two or more of Zr, Al, Ti and Si, more preferably one or more of alumina and zirconia, more preferably zirconia.

Preferably the coating of the second catalyst (b) comprises said metal oxide binder at an amount in the range of from 1 to 8 weight-%, more preferably in the range of from 3 to 7 weight-%, based on the weight of the zeolitic material comprising one or more of copper and iron.

It is preferred that the substrate of the second coating comprises an inlet end, an outlet end, a substrate axial length extending from the inlet end to the outlet end and a plurality of passages defined by internal walls of the substrate extending therethrough, wherein the substrate more preferably is a flow-through substrate.

More preferably the coating of the second catalyst (b) comprises
a bottom coat disposed on the surface of the internal walls of the substrate, said bottom coat comprising the platinum group metal, the non-zeolitic oxidic material and the zeoltic material comprising one or more of copper and iron, and preferably a metal oxide binder as defined in the foregoing; and
a top coat disposed on the bottom coat, said top coat comprising the zeoltic material comprising one or more of copper and iron and preferably a metal oxide binder as defined in the foregoing.

Preferably the bottom coat extends from the inlet end to the outlet end of the substrate axial length over x % of the substrate axial length, wherein x ranges from 90 to 100, preferably from 95 to 100, more preferably from 99 to 100, and the top coat extends from the inlet end to the outlet end of the substrate axial length over y % of the substrate axial length, wherein y ranges from 90 to x, more preferably y=x.

Alternatively, it is preferred that the coating of the second catalyst (b) be a single coat.

In the context of the present invention, it is preferred that the substrate of the second catalyst (b) comprises, more preferably consists of, a ceramic substance, wherein the ceramic substance more preferably comprises, more preferably consists of, one or more of an alumina, a silica, a silicate, an aluminosilicate, more preferably a cordierite or a mullite, an aluminotitanate, a silicon carbide, a zirconia, a magnesia, more preferably a spinel, and a titania, more preferably one or more of a silicon carbide and a cordierite, more preferably a cordierite. It is alternatively preferred that the substrate of the second catalyst (b) comprises, more preferably consists of, a metallic substance.

With regard to the substrate of the second catalyst (b) comprising, more preferably consisting of, a metallic substrate, no specific restriction exits provided that the substrate is suitable for the intended use of the second catalyst comprised in the exhaust gas treatment system of the present invention. It is preferred that the metallic substance comprises, more preferably consists of, oxygen and one or more of iron, chromium and aluminum. The substrate can further be electrically heated.

It is preferred that the substrate of the first catalyst (a), on which substrate the coating of the first catalyst is disposed, and that the substrate of the second catalyst (b), on which substrate the coating of the second catalyst is disposed, together form a single substrate, wherein said single substrate comprises an inlet end and an outlet end, wherein the inlet end is arranged upstream of the outlet end, and wherein the coating of the first catalyst is disposed on said single substrate from the inlet end towards the outlet end of said single substrate and the coating of the second catalyst is disposed on said single substrate from the outlet end towards the inlet end of said single substrate, wherein the coating of the first catalyst covers from 25 to 75% of the substrate length and the coating of the second catalyst covers from 25 to 75% of the substrate length. Preferably the coating of the first catalyst covers from 30 to 70%, more preferably from 35 to 65%, more preferably from 45 to 55%, of the substrate length and the coating of the second catalyst covers from 30 to 70%, more preferably from 35 to 65%, more preferably on from 45 to 55% of the substrate length.

It is preferred that the coating of the first catalyst and the coating of the second catalyst do not overlap.

It was a further object of the present invention to provide a catalyst for the selective catalytic reduction of NOx, for the ammonia oxidation and for the cracking and conversion of a hydrocarbon which exhibits improved catalytic properties and which is able to fully recover after sulfation deactivation. Surprisingly, it was found that the catalyst of the present invention for the selective catalytic reduction of NOx, for the ammonia oxidation and for the cracking and conversion of a hydrocarbon exhibits improved catalytic properties and is able to fully recover after sulfation deactivation.

Therefore, the present invention relates to a catalyst for the selective catalytic reduction of NOx, for the cracking and conversion of a hydrocarbon, and for the oxidation of ammonia, comprising
a substrate comprising an inlet end, an outlet end, a substrate axial length extending from the inlet end to the outlet end and a plurality of passages defined by internal walls of the substrate extending therethrough;
a first coating disposed on the surface of the internal walls of the substrate, said coating comprising a platinum group metal supported on a non-zeolitic oxidic material and further comprises one or more of a vanadium oxide, a tungsten oxide and a zeolitic material comprising one or more of copper and iron;
a second coating disposed on the first coating, said coating comprising a platinum group metal, an 8-membered ring pore zeolitic material comprising one or more of copper and iron, and further comprising a 10- or more membered ring pore zeolitic material.

Preferably the first coating comprises the platinum group metal, more preferably Pt, at a loading, calculated elemental platinum group metal, preferably as elemental Pt, in the range of from 0.1 to 20 g/ft³, more preferably in the range of from 1 to 15 g/ft³, more preferably in the range of from 3 to 10 g/ft³, more preferably in the range of from 4 to 9 g/ft³.

It is preferred that the first coating comprises a zeolitic material having a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI. More preferably the zeolitic material of the first coating has a framework type CHA.

Preferably from 95 to 100 weight-%, more preferably from 98 to 100 weight-%, more preferably from 99 to 100 weight-%, more preferably from 99.5 to 100 weight-%, of the framework structure of the zeolitic material of the first coating consist of Si, Al, and O.

Preferably at most 1 weight-%, more preferably from 0 to 0.5 weight-%, more preferably from 0 to 0.1 weight-%, of the framework structure of said zeolitic material consist of P.

Preferably, in the framework structure of the zeolitic material of the first coating, the molar ratio of Si to Al, calculated as molar SiO₂:Al₂O₃, is in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1.

Preferably the zeolitic material of the first coating, more preferably having a framework type CHA, has a mean crystallite size of at least 0.1 micrometer, more preferably in the range of from 0.1 to 3.0 micrometers, more preferably in the range of from 0.3 to 1.5 micrometer, more preferably in the range of from 0.4 to 1.0 micrometer determined via scanning electron microscopy.

It is preferred that the first coating comprises the zeolitic material at a loading in the range of from 0.1 to 3 g/in³, more preferably in the range of from 0.25 to 1 g/in³, more preferably in the range of from 0.3 to 0.75 g/in³.

Preferably the zeolitic material comprised in the first coating comprises copper, wherein said coating comprises copper in an amount, calculated as CuO, being more preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, more preferably in the range of from 4.5 to 5.25 weight-%, based on the weight of the zeolitic material comprised in the first coating.

Preferably the non-zeolitic oxidic material of the first coating comprises one or more of titania, zirconia, silica, alumina and ceria, more preferably one or more of titania, zirconia and alumina, more preferably one or more of titania and zirconia, more preferably titania.

It is preferred that the first coating comprises said non-zeolitic oxidic material in an amount in the range of from 10 to 30 weight-%, more preferably in the range of from 15 to 25 weight-%, based on the weight of zeolitic material comprising one or more of copper and iron comprised in the first coating.

Preferably from 30 to 100 weight-%, more preferably from 50 to 99 weight-%, more preferably from 70 to 95 weight-%, more preferably from 80 to 92 weight-%, of the non-zeolitic oxidic material of the first coating consist of titania.

Preferably from 5 to 15 weight-%, more preferably from 6 to 12 weight-%, of the non-zeolitic oxidic material consist of silicon, calculated as SiO₂.

It is preferred that the first coating further comprises a metal oxide binder, wherein the metal oxide binder more preferably comprises one or more of zirconia, alumina, titania, silica, and a mixed oxide comprising two or more of Zr, Al, Ti and Si, more preferably one or more of alumina and zirconia, more preferably zirconia.

It is preferred that the first coating comprises a metal oxide binder in an amount in the range of from 1 to 8 weight-%, more preferably in the range of from 3 to 7 weight-%, based on the weight of the zeolitic material comprising one or more of copper and iron comprised in the first coating.

Preferably the first coating comprises
a bottom coat disposed on the surface of the internal walls of the substrate, said bottom coat comprising the platinum group metal, the non-zeolitic oxidic material and the zeolitic material comprising one or more of copper and iron, and preferably a metal oxide binder as defined in the foregoing; and
a top coat disposed on the bottom coat, said top coat comprising the zeoltic material comprising one or more of copper and iron and preferably a metal oxide binder as defined in the foregoing,

wherein the bottom coat more preferably extends from the inlet end to the outlet end of the substrate axial length over x1% of the substrate axial length, wherein x1 ranges from 90 to 100, more preferably from 95 to 100, more preferably from 99 to 100, and the top coat preferably extends from the inlet end to the outlet end of the substrate axial length over y1% of the substrate axial length, wherein y1 ranges from 90 to x, more preferably y1=x1.

Alternatively, it is preferred that the first coating be a single coat.

In the context of the present invention, it is preferred that the first coating extends over 95 to 100%, preferably from 98 to 100%, more preferably from 99 to 100%, of the substrate axial length.

Alternatively, it is preferred that the first coating extends over 20 to 70%, preferably from 40 to 60%, more preferably from 45 to 55% of the substrate axial length. More preferably, the first coating extends from the outlet end towards the inlet end of the substrate.

Preferably from 99 to 100 weight-%, more preferably from 99.5 to 100 weight-%, more preferably from 99.9 to 100 weight-%, of the first coating consists of the platinum group metal, the non-zeolitic oxidic material, the zeolitic material comprising one or more of copper and iron, and preferably a metal oxide binder as defined in the foregoing.

Preferably the platinum group metal comprised in the second coating is selected from the group consisting of palladium, platinum, rhodium, iridium and osmium, more preferably selected from the group consisting of palladium, platinum and rhodium, more preferably selected from the group consisting of palladium and platinum. It is more preferred that the platinum group metal comprised in the second coating is palladium.

Preferably the second coating comprises the platinum group metal at a loading, calculated as elemental platinum group metal, in the range of from 2 to 100 g/ft³, more preferably in the range of from 5 to 80 g/ft³, more preferably in the range of from 7 to 60 g/ft³, more preferably in the range of from 8 to 40 g/ft³, more preferably in the range of from 10 to 30 g/ft³.

Preferably the second coating further comprises a non-zeolitic oxidic material comprises one or more of alumina, zirconia, silica, titania and ceria, more preferably one or more of alumina, zirconia and silica, more preferably one or more of alumina and zirconia, more preferably alumina or zirconia.

Preferably from 30 to 100 weight-%, more preferably from 50 to 99 weight-%, more preferably from 70 to 95 weight-%, more preferably from 80 to 92 weight-%, of the non-zeolitic oxidic material of the second coating consist of zirconia.

Preferably from 5 to 15 weight-%, more preferably from 6 to 12 weight-%, of the non-zeolitic oxidic material consist of lanthanum, calculated as La₂O₃.

It is preferred that the 8-membered ring pore zeolitic material comprised in the second coating has a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI. More preferably the 8-membered ring pore zeolitic material comprised in the second coating has a framework type CHA.

Preferably from 95 to 100 weight-%, more preferably from 98 to 100 weight-%, more preferably from 99 to 100 weight-%, more preferably from 99.5 to 100 weight-%, of the framework structure of the 8-membered ring pore zeolitic material comprised in the second coating consist of Si, Al, and O.

Preferably at most 1 weight-%, more preferably from 0 to 0.5 weight-%, more preferably from 0 to 0.1 weight-%, of the framework structure of the zeolitic material consist of P.

Preferably, in the framework structure of the 8-membered ring pore zeolitic material comprised in the second coating, the molar ratio of Si to Al, calculated as molar SiO₂:Al₂O₃, is in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1, or more preferably in the range of from 25:1 to 33:1.

Preferably the 8-membered ring pore zeolitic material comprised in the second coating, more preferably having a framework type CHA, has a mean crystallite size of at least 0.1 micrometer, more preferably in the range of from 0.1 to 3.0 micrometers, more preferably in the range of from 0.3 to 1.5 micrometer, more preferably in the range of from 0.4 to 1.0 micrometer determined via scanning electron microscopy.

Preferably the second coating comprises the 8-membered ring pore zeolitic material at a loading in the range of from 0.1 to 3.0 g/in³, more preferably in the range of from 0.5 to 2.5 g/in³, more preferably in the range of from 0.7 to 2.2 g/in³, more preferably in the range of from 0.8 to 2.0 g/in³.

Preferably the 8-membered ring pore zeolitic material comprised in the second coating comprises copper, wherein said coating comprises copper in an amount, calculated as CuO, being more preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, based on the weight of the 8-membered ring pore zeolitic material comprised in the second coating. Preferably the 10- or more membered ring pore zeolitic material comprised in the second coating is a zeolitic material having a framework type selected from the group consisting of FER, MFI, BEA, MWW, AFI, MOR, OFF, MFS, MTT, FAU, LTL, MEI, MOR, a mixture of two or more thereof and a mixed type of two or more thereof, preferably selected from the group consisting of FAU, FER, MFI, BEA, MWW, MOR, a mixture of two or more thereof and a mixed type of two or more thereof, more preferably selected from the group consisting of FAU, FER, MFI, and

BEA. It is more preferred that the 10- or more, more preferably 10- or 12-, membered ring pore zeolitic material is a zeolitic material having a framework type FAU or FER or MFI or BEA.

Preferably from 95 to 100 weight-%, more preferably from 98 to 100 weight-%, more preferably from 99 to 100 weight-%, more preferably from 99.5 to 100 weight-%, of the framework structure of the 10- or more membered ring pore zeolitic material consist of Si, Al, and O.

Preferably at most 1 weight-%, more preferably from 0 to 0.5 weight-%, more preferably from 0 to 0.1 weight-%, of the framework structure of the zeolitic material consist of P.

Preferably in the framework structure of the 10- or more membered ring pore zeolitic material, the molar ratio of Si to Al, calculated as molar SiO₂:Al₂O₃, is more preferably in the range of from 2:1 to 60:1, more preferably in the range of from 3:1 to 40:1, more preferably in the range of from 3:1 to 35:1.

Preferably, when the 10- or more membered ring pore zeolitic material comprised in the second coating is a zeolitic material having a framework type BEA, in the framework structure of said zeolitic material, the molar ratio of Si to Al, calculated as molar SiO₂:Al₂O₃, is in the range of from 4:1 to 20:1, more preferably in the range of from 6:1 to 15:1, more preferably in the range of from 8:1 to 12:1.

It is alternatively preferred that, when the 10- or more membered ring pore zeolitic material comprised in the second coating is a zeolitic material having a framework type FER, in the framework structure of said zeolitic material, the molar ratio of Si to Al, calculated as molar SiO₂:Al₂O₃, is in the range of from 10:1 to 30:1, more preferably in the range of from 15:1 to 25:1, more preferably in the range of from 18:1 to 22:1.

It is alternatively preferred that, when the 10- or more membered ring pore zeolitic material comprised in the second coating is a zeolitic material having a framework type FAU, in the framework structure of said zeolitic material, the molar ratio of Si to Al, calculated as molar SiO₂:Al₂O₃, is in the range of from 3:1 to 15:1, more preferably in the range of from 4:1 to 10:1, more preferably in the range of from 4:1 to 8:1.

It is alternatively preferred that, when the 10- or more membered ring pore zeolitic material comprised in the second coating is a zeolitic material having a framework type MFI, in the framework structure of said zeolitic material, the molar ratio of Si to Al, calculated as molar SiO₂:Al₂O₃, is in the range of from 10:1 to 35:1, more preferably in the range of from 20:1 to 32:1, more preferably in the range of from 25:1 to 30:1.

In the context of the present invention, it is preferred that, the 10- or more membered ring pore zeolitic material comprised in the second coating comprises one or more of iron, copper and a rare earth element component, more preferably one or more of iron and a rare earth element component. It is also conceivable that the 10- or more membered ring pore zeolitic material in the second coating be preferably in its H-form.

Preferably said coating comprises the one or more of iron, copper and a rare earth element component in an amount, calculated as the respective oxide, being in the range of from 1 to 20 weight-%, more preferably in the range of from 5 to 20 weight-%, more preferably in the range of from 2 to 8 weight-%, or more preferably in the range of from 10 to 20 weight-%, based on the weight of the 10- or more membered ring pore zeolitic material comprised in the second coating.

It is preferred that said 10- or more membered ring pore zeolitic material comprised in the second coating comprises iron. More preferably the second coating comprises iron in an amount, calculated as Fe₂O₃, in the range of from 2 to 8 weight-%, more preferably in the range of from 2.5 to 6 weight-%, more preferably in the range of from 3 to 5.5 weight-%, based on the weight of the 10- or more membered ring pore zeolitic material comprised in the second coating.

It is alternatively preferred that the 10- or more membered ring pore zeolitic material comprised in the second coating comprises a rare earth element component, wherein the rare earth element component more preferably comprises one or more of La, Ce, Pr, Nd, Pm, Sm, Eu, Gd, Tb, Er, Y and Yb, more preferably comprises one or more of La, Ce, Pr, Nd, Sm, Eu, Y, Yb and Gd, more preferably comprises one or more of La and Ce.

More preferably from 60 to 100 weight-%, more preferably from 80 to 100 weight-%, of the rare earth element component consist of La and/or Ce. In other words, it is preferred that, in the rare earth element component comprised in the second coating, La and/or Ce be the predominant element(s).

It is preferred that, when the 10- or more membered ring pore zeolitic material comprised in the second coating comprises a rare earth element component, the second coating more preferably comprises a rare earth element component in an amount, calculated as the respective oxide(s), in the range of from 10 to 20 weight-%, more preferably in the range of from 12 to 18 weight-%, more preferably in the range of from 14 to 17 weight-%, based on the weight of the 10- or more membered ring pore zeolitic material comprised in the coating (ii).

In the context of the present invention, it is preferred that the second coating extends over 95 to 100%, more preferably from 98 to 100%, more preferably from 99 to 100%, of the substrate axial length.

Preferably the second coating comprises, more preferably consists of,
an inlet coat comprising the platinum group metal and the 10- or more membered ring pore zeolitic material; and
an outlet coat comprising the platinum group metal, a non-zeolitic oxidic material, preferably as defined in the foregoing, and the 8-membered ring pore zeolitic material comprising one or more of copper and iron;

wherein the inlet coat extends over x2% of the substrate axial length from the inlet end towards the outlet end of the substrate, wherein x2 ranges from 20 to 80, more preferably from 30 to 60, and

wherein the outlet coat extends over y2% of the substrate axial length from the outlet end towards the inlet end of the substrate, wherein y2 ranges from 20 to 80, more preferably from 30 to 60.

Preferably the inlet coat of the second coating is disposed on the first coating, and preferably the outlet coat of the second coating is disposed on the first coating, wherein y2 is 100−x2.

It is preferred, in the inlet coat of the second coating, that the platinum group metal is supported on the 10- or more membered ring pore zeolitic material, more preferably comprising one or more of iron, copper and a rare earth element component.

Preferably the platinum group metal in the inlet coat of the second coating is palladium and preferably the 10- or more membered ring pore zeolitic material in the inlet coat of the second coating is a zeolitic material having a framework type BEA, wherein said zeolitic material more preferably comprises one or more of iron, copper and a rare earth element component, more preferably one or more of iron and a rare earth element component, more preferably iron.

It is alternatively preferred that the platinum group metal in the inlet coat of the second coating is palladium and that the 10- or more membered ring pore zeolitic material in the inlet coat of the second coating is a zeolitic material having a framework type FAU, wherein said zeolitic material more preferably comprises one or more of iron, copper and a rare earth element component, more preferably one or more of iron and a rare earth element component, more preferably a rare earth metal element component as defined in the foregoing.

It is alternatively preferred that the platinum group metal of the inlet coat of the second coating is palladium and that the 10- or more membered ring pore zeolitic material in the inlet coat of the second coating is a zeolitic material having a framework type MFI, wherein said zeolitic material more preferably comprises one or more of iron, copper and a rare earth element component, more preferably one or more of iron and a rare earth element component, more preferably iron.

Preferably from 99 to 100 weight-%, more preferably from 99.5 to 100 weight-%, more preferably from 99.9 to 100 weight-%, of the inlet coat of the second coating consists of the platinum group metal, the 10- or more membered ring pore zeolitic material and more preferably one or more of iron, copper and a rare earth element component.

Preferably the inlet coat of the second coating further comprises a non-zeolitic oxidic material, more preferably as defined in the foregoing, wherein the platinum group metal comprised in the inlet coat of the second coating is supported on said non-zeolitic oxidic material, wherein the inlet coat of the second coating more preferably comprises the non-zeolitic oxidic material in an amount in the range of from 10 to 50 weight-% based on the weight of the inlet coat of the second coating.

Preferably the platinum group metal comprised in the inlet coat of the second coating is palladium, the non-zeolitic oxidic material comprised in the inlet coat of the second coating comprises zirconia or alumina, and the 10- or more membered ring pore zeolitic material comprised in the inlet coat of the second coating is a zeolitic material having a framework type BEA, wherein said zeolitic material more preferably comprises one or more of iron, copper and a rare earth element component, more preferably one or more of iron and a rare earth element component, more preferably iron.

Preferably from 99 to 100 weight-%, more preferably from 99.5 to 100 weight-%, more preferably from 99.9 to 100 weight-%, of the inlet coat of the second coating consists of the platinum group metal, the non-zeolitic oxidic material, the 10- or more membered ring pore zeolitic material and preferably one or more of iron, copper and a rare earth element component.

Preferably the inlet coat of the second coating comprises the platinum group metal at a loading, calculated as elemental platinum group metal, in the range of from 5 to 40 g/ft³, more preferably in the range of from 10 to 35 g/ft³, more preferably in the range of from 15 to 30 g/ft³.

Preferably the inlet coat of the second coating comprises the zeolitic material at a loading in the range of from 1 to 3 g/in³, more preferably in the range of from 1.5 to 2.5 g/in³.

Preferably at most 0.1 weight-%, more preferably at most 0.01 weight-%, more preferably at most 0.001 weight-%, of the inlet coat of the second coating consists of an 8-membered ring pore zeolitic material. In other words, it is preferred that the inlet coat of the second coating is substantially free of, more preferably free of, an 8-membered ring pore zeolitic material.

Preferably the platinum group metal of the outlet coat of the second coating is supported on the non-zeolitic oxidic material of the outlet coat of the second coating.

Preferably the outlet coat of the second coating comprises the non-zeolitic oxidic material at a loading in the range of from 0.05 to 1 g/in³, more preferably in the range of from 0.1 to 0.5 g/in³.

Preferably the weight ratio of the 8-membered ring pore zeolitic material of the outlet coat of the second coating relative to the non-zeolitic oxidic material of the outlet coat of the second coating is in the range of from 3:1 to 20:1, more preferably in the range of from 5:1 to 15:1, more preferably in the range of from 8:1 to 12:1.

Preferably in the framework structure of the 8-membered ring pore zeolitic material of the outlet coat of the second coating, the molar ratio of Si to Al, calculated as molar SiO₂:Al₂O₃, is in the range of from 15:1 to 33:1, more preferably in the range of from 15:1 to 20:1. It is more preferred that said outlet coat of the second coating comprises copper in an amount, calculated as CuO, being more preferably in the range of from 2.5 to 5.5 weight-%, more preferably in the range of from 2.75 to 5.5 weight-%, more preferably in the range of from 4.5 to 5.25 weight-%, based on the weight of the 8-membered ring pore zeolitic material comprised in the outlet coat of the second coating.

Alternatively it is preferred that in the framework structure of the 8-membered ring pore zeolitic material of the outlet coat of the second coating, the molar ratio of Si to Al, calculated as molar SiO₂:Al₂O₃, is in the range of from 15:1 to 33:1, more preferably in the range of from 25:1 to 33:1. It is more preferred that said outlet coat of the second coating comprises copper in an amount, calculated as CuO, being more preferably in the range of from 2.5 to 5.5 weight-%, more preferably in the range of from 2.75 to 5.5 weight-%, more preferably in the range of from 3 to 3.75 weight-%, based on the weight of the 8-membered ring pore zeolitic material comprised in the outlet coat of the second coating.

It is preferred that the 8-membered ring pore zeolitic material comprised in the outlet coat of the second coating comprises copper, wherein said outlet coat of the second coating comprises copper in an amount, calculated as CuO, being more preferably in the range of from 2.5 to 5.5 weight-%, more preferably in the range of from 2.75 to 5.5 weight-%, more preferably in the range of from 3 to 3.75 weight-%, or more preferably in the range of from 4.5 to 5.25 weight-%, based on the weight of the 8-membered ring pore zeolitic material comprised in the outlet coat of the second coating.

Preferably the platinum group metal in the outlet coat of the second coating is palladium and the non-zeolitic oxidic material of the outlet coat of the second coating comprises zirconia.

Preferably the outlet coat of the second coating comprises the platinum group metal at a loading, calculated as the elemental platinum group metal, in the range of from 5 to 25 g/ft³, more preferably in the range of from 10 to 20 g/ft³.

Preferably the outlet coat of the second coating comprises the 8-membered ring pore zeolitic material at a loading in the range of from 1 to 4 g/in³, more preferably in the range of from 1.5 to 2.5 g/in³.

Preferably the outlet coat of the second coating further comprises a metal oxide binder, wherein the metal oxide binder more preferably comprises one or more of zirconia, alumina, titania, silica, and a mixed oxide comprising two or more of Zr, Al, Ti and Si, more preferably one or more of alumina and zirconia, more preferably zirconia.

It is preferred that the outlet coat of the second coating comprises said metal oxide binder in an amount in the range of from 1 to 8 weight-%, more preferably in the range of from 3 to 7 weight-%, based on the weight of the 8-membered ring pore zeolitic material comprising one or more of copper and iron.

Preferably from 99 to 100 weight-%, more preferably from 99.5 to 100 weight-%, more preferably from 99.9 to 100 weight-%, of the outlet coat of the second coating consists of the platinum group metal, the non-zeolitic oxidic material, the 8-membered ring pore zeolitic material comprising one or more of copper and iron, and more preferably a metal oxide binder as defined in the foregoing.

Preferably at most 0.1 weight-%, more preferably at most 0.01 weight-%, more preferably at most 0.001 weight-%, of the outlet coat of the second coating consists of a 10- or more membered ring pore zeolitic material. In other words, it is preferred that the outlet coat of the second coating is substantially free of, more preferably free of, a 10- or more membered ring pore zeolitic material.

Alternatively, it is preferred that the second coating be a single coat.

Preferably the non-zeolitic oxidic material of the second coating comprises zirconia or alumina, wherein the second coating more preferably comprises said non-zeolitic oxidic material at a loading in the range of from 0.05 to 1 g/in³, more preferably in the range of from 0.1 to 0.5 g/in³.

Preferably in the framework structure of the 8-membered ring pore zeolitic material of the second coating, the molar ratio of Si to Al, calculated as molar SiO₂:Al₂O₃, is more preferably in the range of from 15:1 to 20:1.

Preferably the 8-membered ring pore zeolitic material comprised in the second coating comprises copper, wherein said coating comprises copper in an amount, calculated as CuO, being more preferably in the range of from 2.5 to 5.5 weight-%, more preferably in the range of from 4.5 to 5.25 weight-%, based on the weight of the 8-membered ring pore zeolitic material comprised in the second coating.

Preferably the weight ratio of the 8-membered ring pore zeolitic material of the second coating relative to the non-zeolitic oxidic material of the second coating is in the range of from 2:1 to 15:1, more preferably in the range of from 3:1 to 12:1, more preferably in the range of from 5:1 to 9:1.

Preferably the weight ratio of the 8-membered ring pore zeolitic material of the second coating relative to the 10- or more membered ring pore zeolitic material of the second coating is in the range of from 2:1 to 15:1, more preferably in the range of from 3:1 to 12:1, more preferably in the range of from 5:1 to 9:1.

Preferably the 8-membered ring pore zeolitic material of the second coating has a framework type CHA and preferably the 10- or more membered ring pore zeolitic material of the second coating has a framework type BEA and comprises iron.

It is alternatively preferred that the 8-membered ring pore zeolitic material of the second coating has a framework type CHA and that the 10- or more membered ring pore zeolitic material of the second coating has a framework type FAU and comprises a rare earth element component as defined in the foregoing.

It is alternatively preferred that the 8-membered ring pore zeolitic material of the second coating has a framework type CHA and that the 10- or more membered ring pore zeolitic material of the second coating has a framework type MFI and comprises iron.

It is alternatively preferred that the 8-membered ring pore zeolitic material of the second coating has a framework type CHA and that the 10- or more membered ring pore zeolitic material of the second coating has a framework type FER.

In the context of the present invention, it is preferred that the second coating further comprises a metal oxide binder, wherein the metal oxide binder more preferably comprises one or more of zirconia, alumina, titania, silica, and a mixed oxide comprising two or more of Zr, Al, Ti and Si, more preferably one or more of alumina and zirconia, more preferably zirconia. It is more preferred that the second coating comprises said metal oxide binder at an amount in the range of from 1 to 8 weight-%, more preferably in the range of from 3 to 7 weight-%, based on the weight of the 8-membered ring pore zeolitic material comprising one or more of copper and iron.

Preferably from 99 to 100 weight-%, more preferably from 99.5 to 100 weight-%, more preferably from 99.9 to 100 weight-%, of the second coating consists of the 10- or more membered ring pore zeolitic material, optionally comprising one or more of iron, copper and a rare earth element component, the platinum group metal, the 8-membered ring pore zeolitic material comprising one or more of copper and iron, more preferably a non-zeolitic oxidic material as defined in in the foregoing, and more preferably a metal oxide binder as defined in the foregoing.

Preferably the substrate of the catalyst for the selective catalytic reduction of NOx, for the cracking and conversion of a hydrocarbon, and for the oxidation of ammonia is a flow-through substrate or a wall-flow filter substrate, more preferably a flow-through substrate. More preferably the flow-through substrate comprises, more preferably consists of, a ceramic substance, wherein the ceramic substance more preferably comprises, more preferably consists of, one or more of an alumina, a silica, a silicate, an aluminosilicate, more preferably a cordierite or a mullite, an aluminotitanate, a silicon carbide, a zirconia, a magnesia, more preferably a spinel, and a titania, more preferably one or more of a silicon carbide and a cordierite, more preferably a cordierite. It is alternatively more preferred that the flow-through substrate comprises, more preferably consists of, a metallic substance. As to the metallic substance, no specific restriction exits provided that the substrate is suitable for the intended use of the catalyst for the selective catalytic reduction of NOx, for the cracking and conversion of a hydrocarbon, and for the oxidation of ammonia of the present invention. It is preferred that the metallic substance comprises, more preferably consists of, oxygen and one or more of iron, chromium and aluminum. It can be preferred that the substrate is electrically heated.

It is preferred that the catalyst for the selective catalytic reduction of NOx, for the cracking and conversion of a hydrocarbon, and for the oxidation of ammonia of the present invention consists of the substrate, the first coating and the second coating.

The present invention further relates to a method for preparing a catalyst for the cracking and conversion of HC and for the selective catalytic reduction of NOx, preferably the catalyst for the selective catalytic reduction of NOx and for the cracking and conversion of a hydrocarbon according to the present invention, comprising
(1) providing an uncoated substrate, the substrate comprising an inlet end, an outlet end, a substrate axial length extending from the inlet end to the outlet end and a plurality of passages defined by internal walls of the substrate extending therethrough;
(2) providing a slurry comprising water, a platinum group metal precursor, preferably palladium salt, a non-zeolitic oxidic material, an 8-membered ring pore zeolitic material comprising one or more of copper and iron, and a 10- or more membered ring pore zeolitic material, disposing said slurry on the surface of the internal walls of the substrate, over 90 to 100% of the substrate axial length from the inlet end towards the outlet end of the substrate provided in (1);
(3) calcining the slurry disposed on the substrate obtained according to (2), obtaining a catalyst for the conversion of HC and for the selective catalytic reduction of NOx.

The present invention further relates to a method for preparing a catalyst for the cracking and conversion of HC and for the selective catalytic reduction of NOx, preferably the catalyst for the cracking and conversion of HC and for the selective catalytic reduction of NOx according to the present invention, comprising
(1′) providing an uncoated substrate, the substrate comprising an inlet end, an outlet end, a substrate axial length extending from the inlet end to the outlet end and a plurality of passages defined by internal walls of the substrate extending therethrough;
(2′) providing a first slurry comprising water, a platinum group metal precursor, preferably palladium salt, and a 10- or more membered ring pore zeolitic material, disposing said slurry on the surface of the internal walls of the substrate, over x % of the substrate axial length from the inlet end towards the outlet end of the substrate provided in (1′), wherein x ranges from 20 to 80, preferably 30 to 60;
(3′) calcining the slurry disposed on the substrate obtained according to (2′), obtaining a catalyst comprising an inlet coat;
(4′) providing a second slurry comprising water, a platinum group metal precursor, preferably palladium salt, a non-zeolitic oxidic material and a 8-membered ring pore zeolitic material comprising one or more of copper and iron, disposing said slurry on the surface of the internal walls of the substrate, over y % of the substrate axial length from the out end towards the inlet end of the substrate provided in (1′), wherein x ranges from 20 to 80, preferably 30 to 60,
(5′) calcining the slurry disposed on the substrate obtained according to (4′), obtaining a catalyst comprising an inlet coat and an outlet coat.

Further, the present invention relates to a use of a catalyst for the selective catalytic reduction of NOx and for the cracking and conversion of HC according to the present invention for the simultaneous selective catalytic reduction of NOx and the cracking and conversion of HC.

Further, the present invention relates to a method for the simultaneous selective catalytic reduction of NOx and the cracking and conversion of HC, comprising
(i) providing a gas stream comprising one or more of NOx, ammonia, nitrogen monoxide and a hydrocarbon;
(ii) contacting the gas stream provided in (i) with a catalyst according to the present invention.

Further, the present invention relates to a use of a catalyst for the cracking and conversion of HC, for the selective catalytic reduction of NOx and for the oxidation of ammonia according to the present invention for the simultaneous selective catalytic reduction of NOx, the ammonia oxidation and the cracking and conversion of HC.

The present invention further relates to a method for the simultaneous selective catalytic reduction of NOx, the ammonia oxidation and the cracking and conversion of a hydrocarbon, comprising
(i′) providing a gas stream comprising one or more of NOx, ammonia, nitrogen monoxide and a hydrocarbon;
(ii′) contacting the gas stream provided in (i′) with a catalyst according to the present invention.

The present invention further relates to an exhaust gas treatment system comprising a catalyst for the cracking and conversion of HC, for the selective catalytic reduction of NOx and for the oxidation of ammonia according to the present invention and one or more of a diesel oxidation catalyst, a catalyzed soot filter, a selective catalytic reduction (SCR) catalyst, and an SCR/AMOx catalyst.

Preferably the system comprises the catalyst according to the present invention being a catalyst for the cracking and conversion of HC, for the selective catalytic reduction of NOx and for the oxidation of ammonia, a diesel oxidation catalyst, a catalyzed soot filter, a selective catalytic reduction (SCR) catalyst, and an SCR/AMOx catalyst, wherein the catalyst according to the present invention is located upstream of the diesel oxidation catalyst and of the catalyzed soot filter, wherein the diesel oxidation catalyst is located upstream of the SCR catalyst and wherein the SCR catalyst is located upstream of the SCR/AMOx catalyst.

As to the SCR catalyst used in the system, there is no particular restrictions as long as said catalyst is effective to selectively catalytically reducing NOx. Any suitable SCR catalyst can be used. For example, a vanadium containing SCR catalyst can be used.

Preferably the diesel oxidation catalyst and the catalyzed soot filter are combined, to obtain a diesel oxidation catalyst on filter. The diesel oxidation catalyst more preferably comprises a diesel oxidation catalyst coating coated on a soot filter.

Preferably the system further comprises a reductant injector, more preferably a urea injector, upstream of the SCR catalyst and downstream of the diesel oxidation catalyst.

Alternatively, it is preferred that the system comprises the catalyst according to the present invention, and a diesel oxidation catalyst, wherein the diesel oxidation catalyst is located upstream of the catalyst according to the present invention.

Preferably the system further comprises a HC injector upstream of the diesel oxidation catalyst and a reductant injector, more preferably an urea injector, downstream of the diesel oxidation catalyst and upstream of the catalyst according to the present invention.

Preferably the diesel oxidation catalyst comprises a platinum group metal supported on an oxidic material, more preferably a non-zeolitc oxidic material, wherein the diesel oxidation catalyst more preferably is a layered DOC or a mixed DOC.

The present invention further relates to a method for the simultaneous selective catalytic reduction of NOx and the conversion of a hydrocarbon, generating temperature though an exotherm, for desulfation, comprising
(A) providing a gas stream comprising one or more of NOx, ammonia, nitrogen monoxide and a hydrocarbon;
(B) contacting the gas stream provided in (A) with an exhaust gas treatment system according to the present invention.

The present invention is illustrated by the following first set of embodiments and combinations of embodiments resulting from the dependencies and back-references as indicated. This set of embodiments may be combined with the second set of embodiments below as indicated in the following. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3 and 4”. Further, it is explicitly noted that the following set of embodiments is not the set of claims determining the extent of protection, but represents a suitably structured part of the description directed to general and preferred aspects of the present invention.
1. A catalyst for the selective catalytic reduction of NOx and for the cracking and conversion of a hydrocarbon, comprising
   (i) a substrate comprising an inlet end, an outlet end, a substrate axial length extending from the inlet end to the outlet end and a plurality of passages defined by internal walls of the substrate extending therethrough;
   (ii) a coating disposed on the surface of the internal walls of the substrate, said coating comprising a platinum group metal, an 8-membered ring pore zeolitic material comprising one or more of copper and iron, and further comprising a 10- or more membered ring pore zeolitic material.
2. The catalyst of embodiment 1, wherein the platinum group metal comprised in the coating (ii) is selected from the group consisting of palladium, platinum, rhodium, iridium and osmium, preferably selected from the group consisting of palladium, platinum and rhodium, more preferably selected from the group consisting of palladium and platinum, wherein the platinum group metal comprised in the coating (ii) more preferably is palladium.
3. The catalyst of embodiment 1 or 2, wherein the coating comprises the platinum group metal at a loading, calculated as elemental platinum group metal, in the range of from 2 to 100 g/ft³, preferably in the range of from 5 to 80 g/ft³, more preferably in the range of from 7 to 60 g/ft³, more preferably in the range of from 8 to 40 g/ft³, more preferably in the range of from 10 to 30 g/ft³.
4. The catalyst of any one of embodiments 1 to 3, wherein the coating (ii) further comprises a non-zeolitic oxidic material comprising one or more of alumina, zirconia, silica, titania and ceria, preferably one or more of alumina, zirconia and silica, more preferably one or more of alumina and zirconia, more preferably alumina or zirconia.
5. The catalyst of embodiment 4, wherein from 30 to 100 weight-%, preferably from 50 to 99 weight-%, more preferably from 70 to 95 weight-%, more preferably from 80 to 92 weight-%, of the non-zeolitic oxidic material consist of zirconia,
   wherein preferably from 5 to 15 weight-%, more preferably from 6 to 12 weight-%, of the non-zeolitic oxidic material consist of lanthanum, calculated as La₂O₃.
6. The catalyst of any one of embodiments 1 to 5, wherein the 8-membered ring pore zeolitic material comprised in the coating (ii) has a framework type selected from the group consisting of CHA, AEI, RTH, LEV, DDR, KFI, ERI, AFX, a mixture of two or more thereof and a mixed type of two or more thereof, preferably selected from the group consisting of CHA, AEI, RTH, AFX, a mixture of two or more thereof and a mixed type of two or more thereof, more preferably selected from the group consisting of CHA and AEI, wherein the 8-membered ring pore zeolitic material comprised in the coating (ii) more preferably has a framework type CHA.
7. The catalyst of any one of embodiments 1 to 6, wherein from 95 to 100 weight-%, preferably from 98 to 100 weight-%, more preferably from 99 to 100 weight-%, more preferably from 99.5 to 100 weight-%, of the framework structure of the 8-membered ring pore zeolitic material consist of Si, Al, and O, wherein in the framework structure of said zeolitic material, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1 or more preferably in the range of from 25:1 to 33:1;
   wherein more preferably at most 1 weight-%, more preferably from 0 to 0.5 weight-%, more preferably from 0 to 0.1 weight-%, of the framework structure of the zeolitic material consist of P.
8. The catalyst of any one of embodiments 1 to 7, wherein the 8-membered ring pore zeolitic material comprised in the coating (ii), preferably having a framework type CHA, has a mean crystallite size of at least 0.1 micrometer, preferably in the range of from 0.1 to 3.0 micrometers, more preferably in the range of from 0.3 to 1.5 micrometer, more preferably in the range of from 0.4 to 1.0 micrometer determined via scanning electron microscopy.
9. The catalyst of any one of embodiments 1 to 8, wherein the coating (ii) comprises the zeolitic material at a loading in the range of from 0.1 to 3.0 g/in³, preferably in the range of from 0.5 to 2.5 g/in³, more preferably in the range of from 0.7 to 2.2 g/in³, more preferably in the range of from 0.8 to 2.0 g/in³.
10. The catalyst of any one of embodiments 1 to 9, wherein the 8-membered ring pore zeolitic material comprised in the coating (ii) comprises copper, wherein said coating comprises copper in an amount, calculated as CuO, being preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, based on the weight of the 8-membered ring pore zeolitic material comprised in the coating (ii).
11. The catalyst of any one of embodiments 1 to 10, wherein the 10- or more membered ring pore zeolitic material comprised in the coating (ii) is a zeolitic material having a framework type selected from the group consisting of FER, MFI, BEA, MWW, AFI, MOR, OFF, MFS, MTT, FAU, LTL, MEI, MOR, a mixture of two or more thereof and a mixed type of two or more thereof, preferably selected from the group consisting of FAU, FER, MFI, BEA, MWW, MOR, a mixture of two or more thereof and a mixed type of two or more thereof, more preferably selected from the group consisting of FAU, FER, MFI, and BEA, wherein the 10- or more, preferably the 10- or 12-, membered ring pore zeolitic material more preferably is a zeolitic material having a framework type FAU or FER or MFI or BEA.
12. The catalyst of any one of embodiments 1 to 11, wherein from 95 to 100 weight-%, preferably from 98 to 100 weight-%, more preferably from 99 to 100 weight-%, more preferably from 99.5 to 100 weight-%, of the framework structure of the 10- or more membered ring pore zeolitic material comprised in the coating (ii) consist of Si, Al, and O, wherein, in the framework structure of said zeolitic material, the molar ratio of Si to Al, calculated as molar SiO₂:Al₂O₃, is more preferably in the range of from 2:1 to 60:1, more preferably in the range of from 3:1 to 40:1, more preferably in the range of from 3:1 to 35:1;
   wherein more preferably at most 1 weight-%, more preferably from 0 to 0.5 weight-%, more preferably from 0 to 0.1 weight-%, of the framework structure of the zeolitic material consist of P.
13. The catalyst of embodiment 12, when the 10- or more membered ring pore zeolitic material comprised in the coating (ii) is a zeolitic material having a framework type BEA, wherein, in the framework structure of said zeolitic material, the molar ratio of Si to Al, calculated as molar SiO₂:Al₂O₃, is in the range of from 4:1 to 20:1, preferably in the range of from 6:1 to 15:1, more preferably in the range of from 8:1 to 12:1.
14. The catalyst of embodiment 12, when the 10- or more membered ring pore zeolitic material comprised in the coating (ii) is a zeolitic material having a framework type FER, wherein, in the framework structure of said zeolitic material, the molar ratio of Si to Al, calculated as molar SiO₂:Al₂O₃, is in the range of from 10:1 to 30:1, preferably in the range of from 15:1 to 25:1, more preferably in the range of from 18:1 to 22:1.
15. The catalyst of embodiment 12, when the 10- or more membered ring pore zeolitic material comprised in the coating (ii) is a zeolitic material having a framework type FAU, wherein, in the framework structure of said zeolitic material, the molar ratio of Si to Al, calculated as molar SiO₂:Al₂O₃, is in the range of from 3:1 to 15:1, preferably in the range of from 4:1 to 10:1, more preferably in the range of from 4:1 to 8:1; or
   when the 10- or more membered ring pore zeolitic material comprised in the coating (ii) is a zeolitic material having a framework type MFI, wherein, in the framework structure of said zeolitic material, the molar ratio of Si to Al, calculated as molar SiO₂:Al₂O₃, is in the range of from 10:1 to 35:1, preferably in the range of from 20:1 to 32:1, more preferably in the range of from 25:1 to 30:1.
16. The catalyst of any one of embodiments 1 to 14, wherein the 10- or more membered ring pore zeolitic material comprised in the coating (ii) comprises one or more of iron, copper and a rare earth element component, preferably one or more of iron and a rare earth element component,
   wherein the coating (ii) comprises the one or more of iron, copper and a rare earth element component in an amount, calculated as the respective oxide, being preferably in the range of from 1 to 20 weight-%, more preferably in the range of from 5 to 20 weight-%, more preferably in the range of from 10 to 20 weight-%, based on the weight of the 10- or more membered ring pore zeolitic material comprised in the coating (ii).
17. The catalyst of embodiment 16, wherein said zeolitic material comprises iron or wherein said zeolitic material comprises a rare earth element component, wherein the rare earth element component preferably comprises one or more of La, Ce, Pr, Nd, Pm, Sm, Eu, Gd, Tb, Er, Y and Yb, more preferably comprises one or more of La, Ce, Pr, Nd, Sm, Eu, Y, Yb and Gd, more preferably comprises one or more of La and Ce, wherein from 60 to 100 weight-% of the rare earth element component consist of La and/or Ce.
18. The catalyst of any one of embodiments 1 to 18, wherein the coating (ii) extends over 95 to 100%, preferably from 98 to 100%, more preferably from 99 to 100%, of the substrate axial length.
19. The catalyst of any one of embodiments 1 to 18, wherein the coating according to (ii) comprises, preferably consists of,
   (ii.1) an inlet coat comprising the platinum group metal and the 10- or more membered ring pore zeolitic material; and
   (ii.2) an outlet coat comprising the platinum group metal, a non-zeolitic oxidic material, preferably as defined in embodiment 4 or 5, and the 8-membered ring pore zeolitic material comprising one or more of copper and iron;
   wherein the inlet coat (ii.1) extends over x % of the substrate axial length from the inlet end towards the outlet end of the substrate according to (i), wherein x ranges from 20 to 80, preferably from 30 to 60, and
   wherein the outlet coat (ii.2) extends over y % of the substrate axial length from the outlet end towards the inlet end of the substrate according to (i), wherein y ranges from 20 to 80, preferably from 30 to 60.
20. The catalyst of embodiment 19, wherein the inlet coat (ii.1) is disposed on the surface of the internal walls of the substrate (i), and
   wherein the outlet coat (ii.2) is disposed on the surface of the internal walls of the substrate (i), wherein y is 100−x.
21. The catalyst of embodiment 19 or 20, as far as embodiment 19 depends on embodiment 16 or 17, wherein the platinum group metal is supported on the 10- or more membered ring pore zeolitic material comprising one or more of iron, copper and a rare earth element component.
22. The catalyst of any one of embodiments 19 to 21, wherein the platinum group metal in the inlet coat (ii.1) is palladium and the 10- or more membered ring pore zeolitic material in the inlet coat (ii.1) is a zeolitic material having a framework type BEA, wherein said zeolitic material preferably comprises one or more of iron, copper and a rare earth element component, more preferably one or more of iron and a rare earth element component, more preferably iron.
23. The catalyst of any one of embodiments 19 to 21, wherein the platinum group metal in the inlet coat (ii.1) is palladium and the 10- or more membered ring pore zeolitic material in the inlet coat (ii.1) is a zeolitic material having a framework type FAU, wherein said zeolitic material preferably comprises one or more of iron, copper and a rare earth element component, more preferably one or more of iron and a rare earth element component, more preferably a rare earth element component as defined in embodiment 17.
24. The catalyst of any one of embodiments 19 to 21, wherein the platinum group metal of the inlet coat (ii.1) is palladium and the 10- or more membered ring pore zeolitic material in the inlet coat (ii.1) is a zeolitic material having a framework type MFI, wherein said zeolitic material preferably comprises one or more of iron, copper and a rare earth element component, more preferably one or more of iron and a rare earth element component, more preferably iron.
25. The catalyst of any one of embodiments 19 to 24, wherein from 99 to 100 weight-%, preferably from 99.5 to 100 weight-%, more preferably from 99.9 to 100 weight-%, of the inlet coat (ii.1) consists of the platinum group metal, the 10- or more membered ring pore zeolitic material and preferably one or more of iron, copper and a rare earth element component.
26. The catalyst of embodiment 19 or 20, wherein the inlet coat (ii.1) further comprises a non-zeolitic oxidic material, preferably as defined in embodiment 4 or 5, wherein the platinum group metal comprised in the inlet coat (ii.1) is supported on said non-zeolitic oxidic material, wherein the inlet coat (ii.1) preferably comprises the non-zeolitic oxidic material in an amount in the range of from 5 to 50 weight-%, more preferably in the range of from 10 to 50 weight-%, based on the weight of the inlet coat (ii.1).
27. The catalyst of embodiment 26, wherein the platinum group metal in the inlet coat (ii.1) is palladium, the non-zeolitic oxidic material comprises zirconia or alumina, and the 10- or more membered ring pore zeolitic material in the inlet coat (ii.1) is a zeolitic material having a framework type BEA, wherein said zeolitic material preferably comprises one or more of iron, copper and a rare earth element component, more preferably one or more of iron and a rare earth element component, more preferably iron.
28. The catalyst of embodiment 26 or 27, wherein from 99 to 100 weight-%, preferably from 99.5 to 100 weight-%, more preferably from 99.9 to 100 weight-%, of the inlet coat (ii.1) consists of the platinum group metal, the non-zeolitic oxidic material, the 10- or more membered ring pore zeolitic material and preferably one or more of iron, copper and a rare earth element component.
29. The catalyst of any one of embodiments 19 to 28, wherein the inlet coat (ii.1) comprises the platinum group metal at a loading, calculated as elemental platinum group metal, in the range of from 5 to 40 g/ft³, preferably in the range of from 10 to 35 g/ft³, more preferably in the range of from 15 to 30 g/ft³.
30. The catalyst of any one of embodiments 19 to 29, wherein the inlet coat (ii.1) comprises the zeolitic material at a loading in the range of from 1 to 2 g/in³, preferably in the range of from 1.1 to 1.5 g/in³.
31. The catalyst of any one of embodiments 19 to 30, wherein at most 0.1 weight-%, preferably at most 0.01 weight-%, more preferably at most 0.001 weight-%, of the inlet coat (ii.1) consists of an 8-membered ring pore zeolitic material.
32. The catalyst of any one of embodiments 19 to 31, wherein the platinum group metal of the outlet coat (ii.2) is supported on the non-zeolitic oxidic material of the outlet coat (ii.2).
33. The catalyst of any one of embodiments 19 to 32, wherein the outlet coat (ii.2) comprises the non-zeolitic oxidic material at a loading in the range of from 0.05 to 1 g/in³, preferably in the range of from 0.1 to 0.5 g/in³.
34. The catalyst of any one of embodiments 19 to 33, wherein the weight ratio of the 8-membered ring pore zeolitic material of the outlet coat (ii.2) relative to the non-zeolitic oxidic material of the outlet coat (ii.2) is in the range of from 3:1 to 20:1, preferably in the range of from 5:1 to 15:1, more preferably in the range of from 8:1 to 12:1.
35. The catalyst of any one of embodiments 19 to 34, wherein in the framework structure of the 8-membered ring pore zeolitic material of the outlet coat (ii.2), the molar ratio of Si to Al, calculated as molar SiO₂:Al₂O₃, is in the range of from 15:1 to 33:1, preferably in the range of from 15:1 to 20:1, or preferably in the range of from 25:1 to 33:1.
36. The catalyst of any one of embodiments 19 to 35, wherein the 8-membered ring pore zeolitic material comprised in the outlet coat (ii.2) comprises copper, wherein said outlet coat (ii.2) comprises copper in an amount, calculated as CuO, being preferably in the range of from 2.5 to 5.5 weight-%, more preferably in the range of from 2.75 to 5.5 weight-%, more preferably in the range of from 3 to 3.75 weight-%, or more preferably in the range of from 4.5 to 5.25 weight-%, based on the weight of the 8-membered ring pore zeolitic material comprised in the outlet coat (ii.2).
37. The catalyst of any one of embodiments 19 to 36, wherein the platinum group metal in the outlet coat (ii.2) is palladium and the non-zeolitic oxidic material of the outlet coat (ii.2) comprises zirconia.
38. The catalyst of any one of embodiments 19 to 37, wherein the outlet coat (ii.2) comprises the platinum group metal at a loading, calculated as the elemental platinum group metal, in the range of from 5 to 25 g/ft³, preferably in the range of from 10 to 20 g/ft³.
39. The catalyst of any one of embodiments 19 to 38, wherein the outlet coat (ii.2) comprises the 8-membered ring pore zeolitic material at a loading in the range of from 1 to 4 g/in³, preferably in the range of from 1.5 to 2.5 g/in³.
40. The catalyst of any one of embodiments 19 to 39, wherein the outlet coat (ii.2) further comprises a metal oxide binder, wherein the metal oxide binder preferably comprises one or more of zirconia, alumina, titania, silica, and a mixed oxide comprising two or more of Zr, Al, Ti and Si, more preferably one or more of alumina and zirconia, more preferably zirconia,
   wherein the outlet coat (ii.2) preferably comprises said metal oxide binder in an amount in the range of from 1 to 8 weight-%, more preferably in the range of from 3 to 7 weight-%, based on the weight of the 8-membered ring pore zeolitic material comprising one or more of copper and iron.
41. The catalyst of any one of embodiments 19 to 40, wherein from 99 to 100 weight-%, preferably from 99.5 to 100 weight-%, more preferably from 99.9 to 100 weight-%, of the outlet coat (ii.2) consists of the platinum group metal, the non-zeolitic oxidic material, the 8-membered ring pore zeolitic material comprising one or more of copper and iron, and preferably a metal oxide binder as defined in embodiment 40.
42. The catalyst of any one of embodiments 19 to 41, wherein at most 0.1 weight-%, preferably at most 0.01 weight-%, more preferably at most 0.001 weight-%, of the outlet coat (ii.2) consists of a 10- or more membered ring pore zeolitic material.
43. The catalyst of any one of embodiments 1 to 18, wherein the coating (ii) is a single coat.
44. The catalyst of embodiment 43, wherein the non-zeolitic oxidic material of the coating (ii) comprises zirconia or alumina, wherein the coating (ii) preferably comprises said non-zeolitic oxidic material at a loading in the range of from 0.05 to 1 g/in³, more preferably in the range of from 0.1 to 0.5 g/in³.
45. The catalyst of embodiment 43 or 44, wherein in the framework structure of the 8-membered ring pore zeolitic material of the coating (ii), the molar ratio of Si to Al, calculated as molar SiO₂:Al₂O₃, is more preferably in the range of from 15:1 to 20:1.
46. The catalyst of any one of embodiments 43 to 45, wherein the 8-membered ring pore zeolitic material comprised in the coating (ii) comprises copper, wherein said coating comprises copper in an amount, calculated as CuO, being preferably in the range of from 2.5 to 5.5 weight-%, more preferably in the range of from 4.5 to 5.25 weight-%, based on the weight of the 8-membered ring pore zeolitic material comprised in the coating (ii).
47. The catalyst of any one of embodiments 43 to 46, wherein the weight ratio of the 8-membered ring pore zeolitic material of the coating (ii) relative to the non-zeolitic oxidic material of the coating (ii) is in the range of from 2:1 to 15:1, preferably in the range of from 3:1 to 12:1, more preferably in the range of from 5:1 to 9:1.
48. The catalyst of any one of embodiments 43 to 47, wherein the weight ratio of the 8-membered ring pore zeolitic material of the coating (ii) relative to the 10- or more membered ring pore zeolitic material of the coating (ii) is in the range of from 2:1 to 15:1, preferably in the range of from 3:1 to 12:1, more preferably in the range of from 5:1 to 9:1.
49. The catalyst of any one of embodiments 43 to 48, wherein the 8-membered ring pore zeolitic material of the coating (ii) has a framework type CHA and the 10- or more membered ring pore zeolitic material of the coating (ii) has a framework type BEA and comprises iron.
50. The catalyst of any one of embodiments 43 to 48, wherein the 8-membered ring pore zeolitic material of the coating (ii) has a framework type CHA and the 10- or more membered ring pore zeolitic material of the coating (ii) has a framework type FAU and comprises a rare earth element component as defined in embodiment 17.
51. The catalyst of any one of embodiments 43 to 48, wherein the 8-membered ring pore zeolitic material of the coating (ii) has a framework type CHA and the 10- or more membered ring pore zeolitic material of the coating (ii) has a framework type MFI and comprises iron.
52. The catalyst of any one of embodiments 43 to 48, wherein the 8-membered ring pore zeolitic material of the coating (ii) has a framework type CHA and the 10- or more membered ring pore zeolitic material of the coating (ii) has a framework type FER.
53. The catalyst of any one of embodiments 1 to 18 and 43 to 52, wherein the coating (ii) further comprises a metal oxide binder, wherein the metal oxide binder preferably comprises one or more of zirconia, alumina, titania, silica, and a mixed oxide comprising two or more of Zr, Al, Ti and Si, more preferably one or more of alumina and zirconia, more preferably zirconia,
   wherein the coating (ii) preferably comprises said metal oxide binder at an amount in the range of from 1 to 8 weight-%, more preferably in the range of from 3 to 7 weight-%, based on the weight of the 8-membered ring pore zeolitic material comprising one or more of copper and iron.
54. The catalyst of any one of embodiments 1 to 53, wherein from 99 to 100 weight-%, preferably from 99.5 to 100 weight-%, more preferably from 99.9 to 100 weight-%, of the coating (ii) consists of the 10- or more membered ring pore zeolitic material, optionally comprising one or more of iron, copper and a rare earth element component, the platinum group metal, the 8-membered ring pore zeolitic material comprising one or more of copper and iron, preferably a non-zeolitic oxidic material as defined in embodiment 4 or 5, and more preferably a metal oxide binder as defined in embodiment 40.
55. The catalyst of any one of embodiments 1 to 54, wherein the substrate (i) is a flow-through substrate or a wall-flow filter substrate, preferably a flow-through substrate.
56. The catalyst of embodiment 55, wherein the flow-through substrate (i) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite.
57. The catalyst of embodiment 55, wherein the flow-through substrate (i) comprises, preferably consists of, a metallic substance, wherein the metallic substance preferably comprises, more preferably consists of, oxygen and one or more of iron, chromium and aluminum.
58. The catalyst of embodiment 57, wherein the substrate is electrically heated.
59. The catalyst of any one of embodiments 1 to 58, consisting of the substrate (i) and the coating (ii).
60. An exhaust gas treatment system for treating an exhaust gas stream exiting a diesel engine, said exhaust gas treatment system having an upstream end for introducing said exhaust gas stream into said exhaust gas treatment system, wherein said exhaust gas treatment system comprises
   (a) a first catalyst having an inlet end and an outlet end, wherein said catalyst is a catalyst according to any one of embodiments 1 to 58;
   (b) a second catalyst having an inlet end and an outlet end and comprising a coating disposed on a substrate, wherein the coating comprises a platinum group metal supported on a non-zeolitic oxidic material and further comprises one or more of a vanadium oxide, a tungsten oxide and a zeolitic material comprising one or more of copper and iron;
   wherein the first catalyst according to (a) is the first catalyst of the exhaust gas treatment system downstream of the upstream end of the exhaust gas treatment system and wherein the inlet end of the first catalyst is arranged upstream of the outlet end of the first catalyst;
   wherein in the exhaust gas treatment system, the second catalyst according to (b) is located downstream of the first catalyst according to (a) and wherein the inlet end of the second catalyst is arranged upstream of the outlet end of the second catalyst.
61. The exhaust gas treatment system of embodiment 60, wherein the outlet end of the first catalyst according to (a) is in fluid communication with the inlet end of the second catalyst according to (b) and wherein between the outlet end of the first catalyst according to (a) and the inlet end of the second catalyst according to (b), no catalyst for treating the exhaust gas stream exiting the first catalyst is located in the exhaust gas treatment system.
62. The exhaust gas treatment system of embodiment 60 or 61, wherein the platinum group metal of the coating of the second catalyst (b) is selected from the group consisting of platinum, palladium, rhodium, iridium and osmium, preferably selected from the group consisting of platinum, palladium and rhodium, more preferably selected from the group consisting of platinum and palladium, wherein the platinum group metal of the second catalyst (b) more preferably is platinum.
63. The exhaust gas treatment system of any one of embodiments 60 to 62, wherein the coating of the second catalyst (b) comprises the platinum group metal, preferably Pt, at a loading, calculated elemental platinum group metal, preferably as elemental Pt, in the range of from 0.1 to 10 g/ft³, preferably in the range of from 0.2 to 5 g/ft³, more preferably in the range of from 0.5 to 4 g/ft³, more preferably in the range of from 1 to 3 g/ft³.
64. The exhaust gas treatment system of any one of embodiments 60 to 63, wherein the non-zeolitic oxidic material of the coating of the second catalyst (b) comprises one or more of titania, zirconia, silica, alumina and ceria, preferably one or more of titania, zirconia and alumina, more preferably one or more of titania and zirconia, more preferably titania, wherein the coating of the second catalyst (b) comprises said non-zeolitic oxidic material at a loading in the range of from 0.05 to 1 g/in³, preferably in the range of from 0.1 to 0.5 g/in³.
65. The exhaust gas treatment system of embodiment 64, wherein from 30 to 100 weight-%, preferably from 50 to 99 weight-%, more preferably from 70 to 95 weight-%, more preferably from 80 to 92 weight-%, of the non-zeolitic oxidic material consist of titania, wherein preferably from 5 to 15 weight-%, more preferably from 6 to 12 weight-%, of the non-zeolitic oxidic material consist of silicon, calculated as SiO₂.
66. The exhaust gas treatment system of any one of embodiments 60 to 65, wherein the coating of the second catalyst (b) comprises a zeolitic material having a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, wherein the zeolitic material of the coating of the second catalyst (b) more preferably has a framework type CHA.
67. The exhaust gas treatment system of any one of embodiments 60 to 66, wherein from 95 to 100 weight-%, preferably from 98 to 100 weight-%, more preferably from 99 to 100 weight-%, more preferably from 99.5 to 100 weight-%, of the framework structure of the zeolitic material of the coating of the second catalyst (b) consist of Si, Al, and O, wherein in the framework structure of said zeolitic material, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1;
   wherein more preferably at most 1 weight-%, more preferably from 0 to 0.5 weight-%, more preferably from 0 to 0.1 weight-%, of the framework structure of said zeolitic material consist of P.
68. The exhaust gas treatment system of any one of embodiments 60 to 67, wherein the zeolitic material of the coating of the second catalyst (b), preferably having a framework type CHA, has a mean crystallite size of at least 0.1 micrometer, preferably in the range of from 0.1 to 3.0 micrometers, more preferably in the range of from 0.3 to 1.5 micrometer, more preferably in the range of from 0.4 to 1.0 micrometer determined via scanning electron microscopy.
69. The exhaust gas treatment system of any one of embodiments 60 to 68, wherein the coating of the second catalyst (b) comprises the zeolitic material at a loading in the range of from 1 to 6 g/in³, preferably in the range of from 1.5 to 4 g/in³, more preferably in the range of from 2 to 3 g/in³.
70. The exhaust gas treatment system of any one of embodiments 60 to 69, wherein the zeolitic material comprised in the coating of the second catalyst (b) comprises copper, wherein said coating comprises copper in an amount, calculated as CuO, being preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, more preferably in the range of from 4.5 to 5.25 weight-%, based on the weight of the 8-membered ring pore zeolitic material comprised in the coating of the second catalyst (b).
71. The exhaust gas treatment system of any one of embodiments 60 to 70, wherein the coating of the second catalyst (b) further comprises a metal oxide binder, wherein the metal oxide binder preferably comprises one or more of zirconia, alumina, titania, silica, and a mixed oxide comprising two or more of Zr, Al, Ti and Si, more preferably one or more of alumina and zirconia, more preferably zirconia,
   wherein the coating of the second catalyst (b) preferably comprises said metal oxide binder at an amount in the range of from 1 to 8 weight-%, more preferably in the range of from 3 to 7 weight-%, based on the weight of the zeolitic material comprising one or more of copper and iron.
72. The exhaust gas treatment system of any one of embodiments 60 to 71, wherein the substrate of the second coating comprises an inlet end, an outlet end, a substrate axial length extending from the inlet end to the outlet end and a plurality of passages defined by internal walls of the substrate extending therethrough, wherein the substrate preferably is a flow-through substrate.
73. The exhaust gas treatment system of embodiment 72, wherein the coating of the second catalyst (b) comprises
   a bottom coat disposed on the surface of the internal walls of the substrate, said bottom coat comprising the platinum group metal, the non-zeolitic oxidic material and the zeoltic material comprising one or more of copper and iron, and preferably a metal oxide binder as defined in embodiment 62; and
   a top coat disposed on the bottom coat, said top coat comprising the zeoltic material comprising one or more of copper and iron and preferably a metal oxide binder as defined in embodiment 71.
74. The exhaust gas treatment system of embodiment 73, wherein the bottom coat extends from the inlet end to the outlet end of the substrate axial length over x % of the substrate axial length, wherein x ranges from 90 to 100, preferably from 95 to 100, more preferably from 99 to 100, and the top coat extends from the inlet end to the outlet end of the substrate axial length over y % of the substrate axial length, wherein y ranges from 90 to x, preferably y=x.
75. The exhaust gas treatment system of any one of embodiments 60 to 72, wherein the coating of the second catalyst (b) is a single coat.
76. The exhaust gas treatment system of any one of embodiments 60 to 75, wherein the substrate of the second catalyst (b) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite.
77. The exhaust gas treatment system of any one of embodiments 60 to 75, wherein the substrate of the second catalyst (b) comprises, preferably consists of, a metallic substance, wherein the metallic substance preferably comprises, more preferably consists of, oxygen and one or more of iron, chromium and aluminum.
78. The exhaust gas treatment system of embodiment 77, wherein the substrate is electrically heated.
79. The exhaust gas treatment system of any one of embodiments 60 to 78, wherein the substrate of the first catalyst (a), on which substrate the coating of the first catalyst is disposed, and the substrate of the second catalyst (b), on which substrate the coating of the second catalyst is disposed, together form a single substrate, wherein said single substrate comprises an inlet end and an outlet end, wherein the inlet end is arranged upstream of the outlet end, and wherein the coating of the first catalyst is disposed on said single substrate from the inlet end towards the outlet end of said single substrate and the coating of the second catalyst is disposed on said single substrate from the outlet end towards the inlet end of said single substrate, wherein the coating of the first catalyst covers from 25 to 75% of the substrate length and the coating of the second catalyst covers from 25 to 75% of the substrate length.
80. The exhaust gas treatment system of embodiment 79, wherein the coating of the first catalyst covers from 30 to 70%, preferably from 35 to 65%, more preferably from 45 to 55%, of the substrate length and the coating of the second catalyst covers from 30 to 70%, preferably from 35 to 65%, more preferably on from 45 to 55% of the substrate length.
81. The exhaust gas treatment system of embodiment 79 or 80, wherein the coating of the first catalyst and the coating of the second catalyst do not overlap.
82. A catalyst for the selective catalytic reduction of NOx, for the cracking and conversion of a hydrocarbon, and for the oxidation of ammonia, comprising
   a substrate comprising an inlet end, an outlet end, a substrate axial length extending from the inlet end to the outlet end and a plurality of passages defined by internal walls of the substrate extending therethrough;
   a first coating disposed on the surface of the internal walls of the substrate, said coating comprising a platinum group metal supported on a non-zeolitic oxidic material and further comprises one or more of a vanadium oxide, a tungsten oxide and a zeolitic material comprising one or more of copper and iron;
   a second coating disposed on the first coating, said coating comprising a platinum group metal, an 8-membered ring pore zeolitic material comprising one or more of copper and iron, and further comprising a 10- or more membered ring pore zeolitic material.
83. The catalyst of embodiment 82, wherein the first coating comprises the platinum group metal, preferably Pt, at a loading, calculated elemental platinum group metal, preferably as elemental Pt, in the range of from 0.1 to 20 g/ft³, preferably in the range of from 1 to 15 g/ft³, more preferably in the range of from 3 to 10 g/ft³, more preferably in the range of from 4 to 9 g/ft³.
84. The catalyst of embodiment 82 or 83, wherein the first coating comprises a zeolitic material having a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, wherein the zeolitic material of the first coating more preferably has a framework type CHA.
85. The catalyst of any one of embodiments 82 to 84, wherein from 95 to 100 weight-%, preferably from 98 to 100 weight-%, more preferably from 99 to 100 weight-%, more preferably from 99.5 to 100 weight-%, of the framework structure of the zeolitic material of the first coating consist of Si, Al, and O, wherein, in the framework structure of said zeolitic material, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1;
   wherein more preferably at most 1 weight-%, more preferably from 0 to 0.5 weight-%, more preferably from 0 to 0.1 weight-%, of the framework structure of said zeolitic material consist of P.
86. The catalyst of any one of embodiments 82 to 85, wherein the zeolitic material of the first coating, preferably having a framework type CHA, has a mean crystallite size of at least 0.1 micrometer, preferably in the range of from 0.1 to 3.0 micrometers, more preferably in the range of from 0.3 to 1.5 micrometer, more preferably in the range of from 0.4 to 1.0 micrometer determined via scanning electron microscopy.
87. The catalyst of any one of embodiments 82 to 86, wherein the first coating comprises the zeolitic material at a loading in the range of from 0.1 to 3 g/in³, preferably in the range of from 0.25 to 1 g/in³, more preferably in the range of from 0.3 to 0.75 g/in³.
88. The catalyst of any one of embodiments 82 to 87, wherein the zeolitic material comprised in the first coating comprises copper, wherein said coating comprises copper in an amount, calculated as CuO, being preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, more preferably in the range of from 4.5 to 5.25 weight-%, based on the weight of the zeolitic material comprised in the first coating.
89. The catalyst of any one of embodiments 82 to 88, wherein the non-zeolitic oxidic material of the first coating supporting the platinum group metal comprises one or more of titania, zirconia, silica, alumina and ceria, preferably one or more of titania, zirconia and alumina, more preferably one or more of titania and zirconia, more preferably titania, wherein the first coating preferably comprises said non-zeolitic oxidic material in an amount in the range of from 10 to 30 weight-%, more preferably in the range of from 15 to 25 weight-%, based on the weight of zeolitic material comprising one or more of copper and iron comprised in the first coating.
90. The catalyst of embodiment 89, wherein from 30 to 100 weight-%, preferably from 50 to 99 weight-%, more preferably from 70 to 95 weight-%, more preferably from 80 to 92 weight-%, of the non-zeolitic oxidic material of the first coating consist of titania, wherein preferably from 5 to 15 weight-%, more preferably from 6 to 12 weight-%, of the non-zeolitic oxidic material consist of silicon, calculated as SiO₂.
91. The catalyst of any one of embodiments 82 to 90, wherein the first coating further comprises a metal oxide binder, wherein the metal oxide binder preferably comprises one or more of zirconia, alumina, titania, silica, and a mixed oxide comprising two or more of Zr, Al, Ti and Si, more preferably one or more of alumina and zirconia, more preferably zirconia, wherein the first coating preferably comprises said metal oxide binder in an amount in the range of from 1 to 8 weight-%, more preferably in the range of from 3 to 7 weight-%, based on the weight of the zeolitic material comprising one or more of copper and iron comprised in the first coating.
92. The catalyst of any one of embodiments 82 to 91, wherein the first coating comprises
   a bottom coat disposed on the surface of the internal walls of the substrate, said bottom coat comprising the platinum group metal, the non-zeolitic oxidic material and the zeolitic material comprising one or more of copper and iron, and preferably a metal oxide binder as defined in embodiment 91; and
   a top coat disposed on the bottom coat, said top coat comprising the zeoltic material comprising one or more of copper and iron and preferably a metal oxide binder as defined in embodiment 91, wherein the bottom coat preferably extends from the inlet end to the outlet end of the substrate axial length over x1% of the substrate axial length, wherein x1 ranges from 90 to 100, more preferably from 95 to 100, more preferably from 99 to 100, and the top coat preferably extends from the inlet end to the outlet end of the substrate axial length over y1% of the substrate axial length, wherein y1 ranges from 90 to x, more preferably y1=x1.
93. The catalyst of any one of embodiments 82 to 91, wherein the first coating is a single coat.
94. The catalyst of any one of embodiments 82 to 93, wherein the first coating extends over 95 to 100%, preferably from 98 to 100%, more preferably from 99 to 100%, of the substrate axial length; or
   wherein the first coating extends over 20 to 70%, preferably from 40 to 60%, more preferably from 45 to 55% of the substrate axial length; wherein more preferably first coating extends from the outlet end towards the inlet end of the substrate.
95. The catalyst of any one of embodiments 82 to 94, wherein from 99 to 100 weight-%, preferably from 99.5 to 100 weight-%, more preferably from 99.9 to 100 weight-%, of the first coating consists of the platinum group metal, the non-zeolitic oxidic material, the zeolitic material comprising one or more of copper and iron, and preferably a metal oxide binder as defined in embodiment 91.
96. The catalyst of any one of embodiments 82 to 95, wherein the platinum group metal comprised in the second coating is selected from the group consisting of palladium, platinum, rhodium, iridium and osmium, preferably selected from the group consisting of palladium, platinum and rhodium, more preferably selected from the group consisting of palladium and platinum, wherein the platinum group metal comprised in the second coating more preferably is palladium.
97. The catalyst of any one of embodiments 82 to 96, wherein the second coating comprises the platinum group metal at a loading, calculated as elemental platinum group metal, in the range of from 2 to 100 g/ft³, preferably in the range of from 5 to 80 g/ft³, more preferably in the range of from 7 to 60 g/ft³, more preferably in the range of from 8 to 40 g/ft³, more preferably in the range of from 10 to 30 g/ft³.
98. The catalyst of any one of embodiments 82 to 97, wherein the second coating further comprises a non-zeolitic oxidic material comprises one or more of alumina, zirconia, silica, titania and ceria, preferably one or more of alumina, zirconia and silica, more preferably one or more of alumina and zirconia, more preferably alumina or zirconia.
99. The catalyst of embodiment 98, wherein from 30 to 100 weight-%, preferably from 50 to 99 weight-%, more preferably from 70 to 95 weight-%, more preferably from 80 to 92 weight-%, of the non-zeolitic oxidic material of the second coating consist of zirconia, wherein preferably from 5 to 15 weight-%, more preferably from 6 to 12 weight-%, of the non-zeolitic oxidic material consist of lanthanum, calculated as La₂O₃.
100. The catalyst of any one of embodiments 82 to 99, wherein the 8-membered ring pore zeolitic material comprised in the second coating has a framework type selected from the group consisting of CHA, AEI, RTH, LEV, DDR, KFI, ERI, AFX, a mixture of two or more thereof and a mixed type of two or more thereof, more preferably selected from the group consisting of CHA, AEI, RTH, AFX, a mixture of two or more thereof and a mixed type of two or more thereof, more preferably selected from the group consisting of CHA and AEI, wherein the 8-membered ring pore zeolitic material comprised in the second coating more preferably has a framework type CHA.
101. The catalyst of any one of embodiments 82 to 100, wherein from 95 to 100 weight-%, preferably from 98 to 100 weight-%, more preferably from 99 to 100 weight-%, more preferably from 99.5 to 100 weight-%, of the framework structure of the 8-membered ring pore zeolitic material comprised in the second coating consist of Si, Al, and O, wherein, in the framework structure of said zeolitic material, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 33:1, more preferably in the range of from 15:1 to 20:1, or more preferably in the range of from 25:1 to 33:1;
   wherein more preferably at most 1 weight-%, more preferably from 0 to 0.5 weight-%, more preferably from 0 to 0.1 weight-%, of the framework structure of the zeolitic material consist of P.
102. The catalyst of any one of embodiments 82 to 101, wherein the 8-membered ring pore zeolitic material comprised in the second coating, preferably having a framework type CHA, has a mean crystallite size of at least 0.1 micrometer, preferably in the range of from 0.1 to 3.0 micrometers, more preferably in the range of from 0.3 to 1.5 micrometer, more preferably in the range of from 0.4 to 1.0 micrometer determined via scanning electron microscopy.
103. The catalyst of any one of embodiments 82 to 102, wherein the second coating comprises the 8-membered ring pore zeolitic material at a loading in the range of from 0.1 to 3.0 g/in³, preferably in the range of from 0.5 to 2.5 g/in³, more preferably in the range of from 0.7 to 2.2 g/in³, more preferably in the range of from 0.8 to 2.0 g/in³.
104. The catalyst of any one of embodiments 82 to 103, wherein the 8-membered ring pore zeolitic material comprised in the second coating comprises copper, wherein said coating comprises copper in an amount, calculated as CuO, being preferably in the range of from 1 to 15 weight-%, more preferably in the range of from 1.25 to 10 weight-%, more preferably in the range of from 1.5 to 7 weight-%, more preferably in the range of from 2 to 6 weight-%, more preferably in the range of from 2.5 to 5.5 weight-%, based on the weight of the 8-membered ring pore zeolitic material comprised in the second coating.
105. The catalyst of any one of embodiments 82 to 104, wherein the 10- or more membered ring pore zeolitic material comprised in the second coating is a zeolitic material having a framework type selected from the group consisting of FER, MFI, BEA, MWW, AFI, MOR, OFF, MFS, MTT, FAU, LTL, MEI, MOR, a mixture of two or more thereof and a mixed type of two or more thereof, preferably selected from the group consisting of FAU, FER, MFI, BEA, MWW, MOR, a mixture of two or more thereof and a mixed type of two or more thereof, more preferably selected from the group consisting of FAU, FER, MFI, and BEA, wherein the 10- or more, preferably 10- or 12-, membered ring pore zeolitic material more preferably is a zeolitic material having a framework type FAU or FER or MFI or BEA.
106. The catalyst of any one of embodiments 82 to 105, wherein from 95 to 100 weight-%, preferably from 98 to 100 weight-%, more preferably from 99 to 100 weight-%, more preferably from 99.5 to 100 weight-%, of the framework structure of the 10- or more membered ring pore zeolitic material consist of Si, Al, and O, wherein, in the framework structure of said zeolitic material, the molar ratio of Si to Al, calculated as molar SiO₂:Al₂O₃, is more preferably in the range of from 2:1 to 60:1, more preferably in the range of from 3:1 to 40:1, more preferably in the range of from 3:1 to 35:1;
   wherein more preferably at most 1 weight-%, more preferably from 0 to 0.5 weight-%, more preferably from 0 to 0.1 weight-%, of the framework structure of the zeolitic material consist of P.
107. The catalyst of embodiment 106, when the 10- or more membered ring pore zeolitic material comprised in the second coating is a zeolitic material having a framework type BEA, wherein, in the framework structure of said zeolitic material, the molar ratio of Si to Al, calculated as molar SiO₂:Al₂O₃, is in the range of from 4:1 to 20:1, preferably in the range of from 6:1 to 15:1, more preferably in the range of from 8:1 to 12:1.
108. The catalyst of embodiment 106, when the 10- or more membered ring pore zeolitic material comprised in the second coating is a zeolitic material having a framework type FER, wherein, in the framework structure of said zeolitic material, the molar ratio of Si to Al, calculated as molar SiO₂:Al₂O₃, is in the range of from 10:1 to 30:1, preferably in the range of from 15:1 to 25:1, more preferably in the range of from 18:1 to 22:1.
109. The catalyst of embodiment 106, when the 10- or more membered ring pore zeolitic material comprised in the second coating is a zeolitic material having a framework type FAU, wherein, in the framework structure of said zeolitic material, the molar ratio of Si to Al, calculated as molar SiO₂:Al₂O₃, is in the range of from 3:1 to 15:1, preferably in the range of from 4:1 to 10:1, more preferably in the range of from 4:1 to 8:1.
110. The catalyst of embodiment 106, when the 10- or more membered ring pore zeolitic material comprised in the second coating is a zeolitic material having a framework type MFI, wherein, in the framework structure of said zeolitic material, the molar ratio of Si to Al, calculated as molar SiO₂:Al₂O₃, is in the range of from 10:1 to 35:1, preferably in the range of from 20:1 to 32:1, more preferably in the range of from 25:1 to 30:1.
111. The catalyst of any one of embodiments 82 to 110, wherein the 10- or more membered ring pore zeolitic material comprised in the second coating comprises one or more of iron, copper and a rare earth element component, preferably one or more of iron and a rare earth element component,
   wherein said coating comprises the one or more of iron, copper and a rare earth element component in an amount, calculated as the respective oxide, being preferably in the range of from 1 to 20 weight-%, more preferably in the range of from 2 to 19 weight-%, more preferably in the range of from 3 to 18 weight-%, more preferably in the range of from 3 to 6 weight-% or more preferably in the range of from 10 to 18 weight-%, based on the weight of the 10- or more membered ring pore zeolitic material comprised in the second coating.

112. The catalyst of embodiment 111, wherein said zeolitic material comprised in the second coating comprises iron or
wherein said zeolitic material comprised in the second coating comprises a rare earth element component, wherein the rare earth element component preferably comprises one or more of La, Ce, Pr, Nd, Pm, Sm, Eu, Gd, Tb, Er, Y and Yb, more preferably comprises one or more of La, Ce, Pr, Nd, Sm, Eu, Y, Yb and Gd, more preferably comprises one or more of La and Ce, wherein from 60 to 100 weight-% of the rare earth element component consist of La and/or Ce.
113. The catalyst of any one of embodiments 82 to 112, wherein the second coating extends over 95 to 100%, preferably from 98 to 100%, more preferably from 99 to 100%, of the substrate axial length.
114. The catalyst of any one of embodiments 82 to 113, wherein the second coating comprises, preferably consists of,
   an inlet coat comprising the platinum group metal and the 10- or more membered ring pore zeolitic material; and
   an outlet coat comprising the platinum group metal, a non-zeolitic oxidic material, preferably as defined in embodiment 98 or 99, and the 8-membered ring pore zeolitic material comprising one or more of copper and iron;
   wherein the inlet coat extends over x2% of the substrate axial length from the inlet end towards the outlet end of the substrate, wherein x2 ranges from 20 to 80, preferably from 30 to 60, and
   wherein the outlet coat extends over y2% of the substrate axial length from the outlet end towards the inlet end of the substrate, wherein y2 ranges from 20 to 80, preferably from 30 to 60.
115. The catalyst of embodiment 114, wherein the inlet coat of the second coating is disposed on the first coating, and
   wherein the outlet coat of the second coating is disposed on the first coating, wherein y2 is 100−x2.
116. The catalyst of embodiment 114 or 115, as far as embodiment 114 depends on embodiment 112 or 113, wherein, in the inlet coat of the second coating, the platinum group metal is supported on the 10- or more membered ring pore zeolitic material, preferably comprising one or more of iron, copper and a rare earth element component.
117. The catalyst of any one of embodiments 114 to 116, wherein the platinum group metal in the inlet coat of the second coating is palladium and the 10- or more membered ring pore zeolitic material in the inlet coat of the second coating is a zeolitic material having a framework type BEA, wherein said zeolitic material preferably comprises one or more of iron, copper and a rare earth element component, more preferably one or more of iron and a rare earth element component, more preferably iron.
118. The catalyst of any one of embodiments 114 to 116, wherein the platinum group metal in the inlet coat of the second coating is palladium and the 10- or more membered ring pore zeolitic material in the inlet coat of the second coating is a zeolitic material having a framework type FAU, wherein said zeolitic material preferably comprises one or more of iron, copper and a rare earth element component, more preferably one or more of iron and a rare earth element component, more preferably a rare earth metal element component as defined in embodiment 112.
119. The catalyst of any one of embodiments 114 to 116, wherein the platinum group metal of the inlet coat of the second coating is palladium and the 10- or more membered ring pore zeolitic material in the inlet coat of the second coating is a zeolitic material having a framework type MFI, wherein said zeolitic material preferably comprises one or more of iron, copper and a rare earth element component, more preferably one or more of iron and a rare earth element component, more preferably iron.
120. The catalyst of any one of embodiments 114 to 119, wherein from 99 to 100 weight-%, preferably from 99.5 to 100 weight-%, more preferably from 99.9 to 100 weight-%, of the inlet coat of the second coating consists of the platinum group metal, the 10- or more membered ring pore zeolitic material and preferably one or more of iron, copper and a rare earth element component.
121. The catalyst of embodiment 114 or 115, wherein the inlet coat of the second coating further comprises a non-zeolitic oxidic material, preferably as defined in embodiment 4 or 5, wherein the platinum group metal comprised in the inlet coat of the second coating is supported on said non-zeolitic oxidic material, wherein the inlet coat of the second coating preferably comprises the non-zeolitic oxidic material in an amount in the range of from 10 to 50 weight-% based on the weight of the inlet coat of the second coating.
122. The catalyst of embodiment 121, wherein the platinum group metal comprised in the inlet coat of the second coating is palladium, the non-zeolitic oxidic material comprised in the inlet coat of the second coating comprises zirconia or alumina, and the 10- or more membered ring pore zeolitic material comprised in the inlet coat of the second coating is a zeolitic material having a framework type BEA, wherein said zeolitic material preferably comprises one or more of iron, copper and a rare earth element component, more preferably one or more of iron and a rare earth element component, more preferably iron.
123. The catalyst of embodiment 121 or 122, wherein from 99 to 100 weight-%, preferably from 99.5 to 100 weight-%, more preferably from 99.9 to 100 weight-%, of the inlet coat of the second coating consists of the platinum group metal, the non-zeolitic oxidic material, the 10- or more membered ring pore zeolitic material and preferably one or more of iron, copper and a rare earth element component.
124. The catalyst of any one of embodiments 114 to 123, wherein the inlet coat of the second coating comprises the platinum group metal at a loading, calculated as elemental platinum group metal, in the range of from 5 to 40 g/ft³, preferably in the range of from 10 to 35 g/ft³, more preferably in the range of from 15 to 30 g/ft³.
125. The catalyst of any one of embodiments 114 to 124, wherein the inlet coat of the second coating comprises the zeolitic material at a loading in the range of from 1 to 3 g/in³, preferably in the range of from 1.5 to 2.5 g/in³.
126. The catalyst of any one of embodiments 114 to 125, wherein at most 0.1 weight-%, preferably at most 0.01 weight-%, more preferably at most 0.001 weight-%, of the inlet coat of the second coating consists of an 8-membered ring pore zeolitic material.
127. The catalyst of any one of embodiments 114 to 126, wherein the platinum group metal of the outlet coat of the second coating is supported on the non-zeolitic oxidic material of the outlet coat of the second coating.
128. The catalyst of any one of embodiments 114 to 127, wherein the outlet coat of the second coating comprises the non-zeolitic oxidic material at a loading in the range of from 0.05 to 1 g/in³, preferably in the range of from 0.1 to 0.5 g/in³.
129. The catalyst of any one of embodiments 114 to 128, wherein the weight ratio of the 8-membered ring pore zeolitic material of the outlet coat of the second coating relative to the non-zeolitic oxidic material of the outlet coat of the second coating is in the range of from 3:1 to 20:1, preferably in the range of from 5:1 to 15:1, more preferably in the range of from 8:1 to 12:1.
130. The catalyst of any one of embodiments 114 to 129, wherein in the framework structure of the 8-membered ring pore zeolitic material of the outlet coat of the second coating, the molar ratio of Si to Al, calculated as molar SiO₂:Al₂O₃, is in the range of from 15:1 to 33:1, preferably in the range of from 15:1 to 20:1, or preferably in the range of from 25:1 to 33:1.
131. The catalyst of any one of embodiments 114 to 130, wherein the 8-membered ring pore zeolitic material comprised in the outlet coat of the second coating comprises copper, wherein said outlet coat of the second coating comprises copper in an amount, calculated as CuO, being preferably in the range of from 2.5 to 5.5 weight-%, more preferably in the range of from 2.75 to 5.5 weight-%, more preferably in the range of from 3 to 3.75 weight-%, or more preferably in the range of from 4.5 to 5.25 weight-%, based on the weight of the 8-membered ring pore zeolitic material comprised in the outlet coat of the second coating.
132. The catalyst of any one of embodiments 114 to 131, wherein the platinum group metal in the outlet coat of the second coating is palladium and the non-zeolitic oxidic material of the outlet coat of the second coating comprises zirconia.
133. The catalyst of any one of embodiments 114 to 132, wherein the outlet coat of the second coating comprises the platinum group metal at a loading, calculated as the elemental platinum group metal, in the range of from 5 to 25 g/ft³, preferably in the range of from 10 to 20 g/ft³.
134. The catalyst of any one of embodiments 114 to 133, wherein the outlet coat of the second coating comprises the 8-membered ring pore zeolitic material at a loading in the range of from 1 to 4 g/in³, preferably in the range of from 1.5 to 2.5 g/in³.
135. The catalyst of any one of embodiments 114 to 134, wherein the outlet coat of the second coating further comprises a metal oxide binder, wherein the metal oxide binder preferably comprises one or more of zirconia, alumina, titania, silica, and a mixed oxide comprising two or more of Zr, Al, Ti and Si, more preferably one or more of alumina and zirconia, more preferably zirconia,
   wherein the outlet coat of the second coating preferably comprises said metal oxide binder in an amount in the range of from 1 to 8 weight-%, more preferably in the range of from 3 to 7 weight-%, based on the weight of the 8-membered ring pore zeolitic material comprising one or more of copper and iron.
136. The catalyst of any one of embodiments 114 to 135, wherein from 99 to 100 weight-%, preferably from 99.5 to 100 weight-%, more preferably from 99.9 to 100 weight-%, of the outlet coat of the second coating consists of the platinum group metal, the non-zeolitic oxidic material, the 8-membered ring pore zeolitic material comprising one or more of copper and iron, and preferably a metal oxide binder as defined in embodiment 135.
137. The catalyst of any one of embodiments 114 to 136, wherein at most 0.1 weight-%, preferably at most 0.01 weight-%, more preferably at most 0.001 weight-%, of the outlet coat of the second coating consists of a 10- or more membered ring pore zeolitic material.
138. The catalyst of any one of embodiments 82 to 113, wherein the second coating is a single coat.
139. The catalyst of embodiment 138, wherein the non-zeolitic oxidic material of the second coating comprises zirconia or alumina, wherein the second coating preferably comprises said non-zeolitic oxidic material at a loading in the range of from 0.05 to 1 g/in³, more preferably in the range of from 0.1 to 0.5 g/in³.
140. The catalyst of embodiment 138 or 139, wherein in the framework structure of the 8-membered ring pore zeolitic material of the second coating, the molar ratio of Si to Al, calculated as molar SiO₂:Al₂O₃, is more preferably in the range of from 15:1 to 20:1.
141. The catalyst of any one of embodiments 138 to 140, wherein the 8-membered ring pore zeolitic material comprised in the second coating comprises copper, wherein said coating comprises copper in an amount, calculated as CuO, being preferably in the range of from 2.5 to 5.5 weight-%, more preferably in the range of from 4.5 to 5.25 weight-%, based on the weight of the 8-membered ring pore zeolitic material comprised in the second coating.
142. The catalyst of any one of embodiments 138 to 141, wherein the weight ratio of the 8-membered ring pore zeolitic material of the second coating relative to the non-zeolitic oxidic material of the second coating is in the range of from 2:1 to 15:1, preferably in the range of from 3:1 to 12:1, more preferably in the range of from 5:1 to 9:1.
143. The catalyst of any one of embodiments 138 to 142, wherein the weight ratio of the 8-membered ring pore zeolitic material of the second coating relative to the 10- or more membered ring pore zeolitic material of the second coating is in the range of from 2:1 to 15:1, preferably in the range of from 3:1 to 12:1, more preferably in the range of from 5:1 to 9:1.
144. The catalyst of any one of embodiments 138 to 143, wherein the 8-membered ring pore zeolitic material of the second coating has a framework type CHA and the 10- or more membered ring pore zeolitic material of the second coating has a framework type BEA and comprises iron.
145. The catalyst of any one of embodiments 138 to 143, wherein the 8-membered ring pore zeolitic material of the second coating has a framework type CHA and the 10- or more membered ring pore zeolitic material of the second coating has a framework type FAU and comprises a rare earth element component as defined in embodiment 112.
146. The catalyst of any one of embodiments 138 to 143, wherein the 8-membered ring pore zeolitic material of the second coating has a framework type CHA and the 10- or more membered ring pore zeolitic material of the second coating has a framework type MFI and comprises iron.
147. The catalyst of any one of embodiments 138 to 143, wherein the 8-membered ring pore zeolitic material of the second coating has a framework type CHA and the 10- or more membered ring pore zeolitic material of the second coating has a framework type FER.
148. The catalyst of any one of embodiments 82 to 113 and 138 to 147, wherein the second coating further comprises a metal oxide binder, wherein the metal oxide binder preferably comprises one or more of zirconia, alumina, titania, silica, and a mixed oxide comprising two or more of Zr, Al, Ti and Si, more preferably one or more of alumina and zirconia, more preferably zirconia,
   wherein the second coating preferably comprises said metal oxide binder at an amount in the range of from 1 to 8 weight-%, more preferably in the range of from 3 to 7 weight-%, based on the weight of the 8-membered ring pore zeolitic material comprising one or more of copper and iron.
149. The catalyst of any one of embodiments 82 to 148, wherein from 99 to 100 weight-%, preferably from 99.5 to 100 weight-%, more preferably from 99.9 to 100 weight-%, of the second coating consists of the 10- or more membered ring pore zeolitic material, optionally comprising one or more of iron, copper and a rare earth element component, the platinum group metal, the 8-membered ring pore zeolitic material comprising one or more of copper and iron, preferably a non-zeolitic oxidic material as defined in embodiment 98 or 99, and more preferably a metal oxide binder as defined in embodiment 148.
150. The catalyst of any one of embodiments 82 to 149, wherein the substrate is a flow-through substrate or a wall-flow filter substrate, preferably a flow-through substrate.
151. The catalyst of embodiment 150, wherein the flow-through substrate comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite.
152. The catalyst of embodiment 151, wherein the flow-through substrate comprises, preferably consists of, a metallic substance, wherein the metallic substance preferably comprises, more preferably consists of, oxygen and one or more of iron, chromium and aluminum.
153. The catalyst of embodiment 152, wherein the substrate is electrically heated.
154. The catalyst of any one of embodiments 82 to 153, consisting of the substrate, the first coating and the second coating.
155. A method for preparing a catalyst for the cracking and conversion of HC and for the selective catalytic reduction of NOx, preferably the catalyst according to any one of embodiments 1 to 59, comprising
   (1) providing an uncoated substrate, the substrate comprising an inlet end, an outlet end, a substrate axial length extending from the inlet end to the outlet end and a plurality of passages defined by internal walls of the substrate extending therethrough;
   (2) providing a slurry comprising water, a platinum group metal precursor, preferably palladium salt, a non-zeolitic oxidic material, an 8-membered ring pore zeolitic material comprising one or more of copper and iron, and a 10- or more membered ring pore zeolitic material, disposing said slurry on the surface of the internal walls of the substrate, over 90 to 100% of the substrate axial length from the inlet end towards the outlet end of the substrate provided in (1);
   (3) calcining the slurry disposed on the substrate obtained according to (2), obtaining a catalyst for the conversion of HC and for the selective catalytic reduction of NOx.
156. A method for preparing a catalyst for the cracking and conversion of HC and for the selective catalytic reduction of NOx, preferably the catalyst according to any one of embodiments 19 to 42, comprising
   (1′) providing an uncoated substrate, the substrate comprising an inlet end, an outlet end, a substrate axial length extending from the inlet end to the outlet end and a plurality of passages defined by internal walls of the substrate extending therethrough;
   (2′) providing a first slurry comprising water, a platinum group metal precursor, preferably palladium salt, and a 10- or more membered ring pore zeolitic material, disposing said slurry on the surface of the internal walls of the substrate, over x % of the substrate axial length from the inlet end towards the outlet end of the substrate provided in (1′), wherein x ranges from 20 to 80, preferably 30 to 60;
   (3′) calcining the slurry disposed on the substrate obtained according to (2′), obtaining a catalyst comprising an inlet coat;
   (4′) providing a second slurry comprising water, a platinum group metal precursor, preferably palladium salt, a non-zeolitic oxidic material and a 8-membered ring pore zeolitic material comprising one or more of copper and iron, disposing said slurry on the surface of the internal walls of the substrate, over y % of the substrate axial length from the out end towards the inlet end of the substrate provided in (1′), wherein x ranges from 20 to 80, preferably 30 to 60,
   (5′) calcining the slurry disposed on the substrate obtained according to (4′), obtaining a catalyst comprising an inlet coat and an outlet coat.
157. Use of a catalyst for the selective catalytic reduction of NOx and for the cracking and conversion of HC according to any one of embodiments 1 to 59 for the simultaneous selective catalytic reduction of NOx and the cracking and conversion of HC.
158. A method for the simultaneous selective catalytic reduction of NOx and the cracking and conversion of HC, comprising
   (i) providing a gas stream comprising one or more of NOx, ammonia, nitrogen monoxide and a hydrocarbon;
   (ii) contacting the gas stream provided in (i) with a catalyst according to any one of embodiments 1 to 59.
159. Use of a catalyst for the cracking and conversion of HC, for the selective catalytic reduction of NOx and for the oxidation of ammonia according to any one of embodiments 82 to 154 for the simultaneous selective catalytic reduction of NOx, the ammonia oxidation and the cracking and conversion of HC.
160. A method for the simultaneous selective catalytic reduction of NOx, the ammonia oxidation and the cracking and conversion of a hydrocarbon, comprising
   (i′) providing a gas stream comprising one or more of NOx, ammonia, nitrogen monoxide and a hydrocarbon;
   (ii′) contacting the gas stream provided in (i′) with a catalyst according to any one of embodiments 82 to 154.
161. An exhaust gas treatment system comprising
   a catalyst for the cracking and conversion of HC, for the selective catalytic reduction of NOx and for the oxidation of ammonia according to any one of embodiments 1 to 59 or any one of embodiments 82 to 154 and
   one or more of a diesel oxidation catalyst, a catalyzed soot filter, a selective catalytic reduction (SCR) catalyst, and an SCR/AMOx catalyst.
162. The system of embodiment 161, comprising the catalyst according to any one of embodiments 82 to 154, a diesel oxidation catalyst, a catalyzed soot filter, a selective catalytic reduction (SCR) catalyst, and an SCR/AMOx catalyst,
   wherein the catalyst according to any one of embodiments 82 to 154 is located upstream of the diesel oxidation catalyst and of the catalyzed soot filter, wherein the diesel oxidation catalyst is located upstream of the SCR catalyst and wherein the SCR catalyst is located upstream of the SCR/AMOx catalyst.
163. The system of embodiment 162, wherein the diesel oxidation catalyst and the catalyzed soot filter are combined.
164. The system of embodiment 162 or 163, further comprising a urea injector upstream of the SCR catalyst and downstream of the diesel oxidation catalyst.
165. The system of embodiment 161, comprising the catalyst according to any one of embodiments 1 to 59, or any one of embodiments 82 to 154, and a diesel oxidation catalyst, wherein the diesel oxidation catalyst is located upstream of the catalyst according to any one of embodiments 1 to 59 or any one of embodiments 82 to 154.
166. The system of embodiment 165, further comprising a HC injector upstream of the diesel oxidation catalyst and an urea injector downstream of the diesel oxidation catalyst and upstream of the catalyst according to any one of embodiments 1 to 59, or any one of embodiments 82 to 154.
167. The system of any one of embodiments 161 to 166, wherein the diesel oxidation catalyst comprises a platinum group metal supported on an oxidic material, preferably a non-zeolitc oxidic material, wherein the diesel oxidation catalyst preferably is a layered DOC or a mixed DOC.
168. A method for the simultaneous selective catalytic reduction of NOx and the conversion of a hydrocarbon, generating temperature though an exotherm, for desulfation, comprising
   (A) providing a gas stream comprising one or more of NOx, ammonia, nitrogen monoxide and a hydrocarbon;
   (B) contacting the gas stream provided in (A) with an exhaust gas treatment system according to any one of embodiments 60 to 81 or according to any one of embodiments 161 to 167.

In the context of the present invention, the term “the surface of the internal walls” is to be understood as the “naked” or “bare” or “blank” surface of the walls, i.e. the surface of the walls in an untreated state which consists—apart from any unavoidable impurities with which the surface may be contaminated—of the material of the walls.

Further, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

Furthermore, in the context of the present invention, the term “loading of a given component/coating” (in g/in³ or g/ft³) refers to the mass of said component/coating per volume of the substrate, wherein the volume of the substrate is the volume which is defined by the cross-section of the substrate times the axial length of the substrate over which said component/coating is present. For example, if reference is made to the loading of a first coating extending over x % of the axial length of the substrate and having a loading of X g/in³, said loading would refer to X gram of the first coating per x % of the volume (in in³) of the entire substrate.

In the context of the present invention, the term “a 10- or more membered ring pore zeolitic material” preferably means a 10-membered ring pore zeolitic material, a 12-membered ring pore zeolitic material or a 14-membered ring pore zeolitic material, more preferably a 10-membered ring pore zeolitic material or a 12-membered ring pore zeolitic material.

The present invention is further illustrated by the following Examples.

### EXAMPLES

### Reference Example 1: Determination of the Dv90 Values

The particle size distributions were determined by a static light scattering method using Sympatec HELOS equipment, wherein the optical concentration of the sample was in the range of from 5 to 10%.

### Reference Example 2: Preparation of a Cu-CHA Zeolite

The zeolitic material having the framework structure type CHA comprising Cu and used in the examples herein was prepared according to the teaching of U.S. Pat. No. 8,293,199 B2. Particular reference is made to Inventive Example 2 of U.S. Pat. No. 8,293,199 B2, column 15, lines 26 to 52.

### Reference Example 3: Measurement of the BET Specific Surface Area

The BET specific surface area was determined according to DIN 66131 or DIN ISO 9277 using liquid nitrogen.

### Reference Example 4: General Coating Method

In order to coat the flow-through substrate with one or more coatings, the flow-through substrate was suitably immersed vertically in a portion of a given mixture for a specific length of the substrate which was equal to the targeted length of the coating to be applied and vacuum was applied. In this manner, the mixture contacted the walls of the substrate. The sample was left in the mixture for a specific period of time, usually for 1-10 seconds. Vacuum was applied to draw the mixture into the substrate. The substrate was then removed from the mixture. The substrate was rotated about its axis such that the immersed side now points up and a high pressure of air forces the charged mixture through the substrate.

### Reference Example 5: Preparation of a Catalyst not According to the Present Invention

An incipient wetness impregnation of Pd onto a zirconium based oxidic support (88 weight-% of ZrO₂ with 10 weight-% La₂O₃ and 2 weight-% HfO₂, having a BET specific surface area of 67 m²/g, a Dv50 of 3 micrometers and a Dv90 of 16 micrometers). Firstly, the available pore volume of the oxidic support was determined and, based on this value, a diluted palladium salt solution with a volume equal to the available pore volume was made. The diluted solution was then added dropwise to the Zr-based oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the Pd-impregnated ZrO₂ mixture had a Dv90 of 10 micrometers. Separately, a Cu-CHA zeolitic material (Cu: 3.25 weight-%, calculated as CuO, based on the weight of the Cu-CHA, CHA having a Dv90 of 25 micrometers, a SiO₂:Al₂O₃ molar ratio of 31:1, and a BET specific surface area of about 625 m²/g) was added to deionized water, forming a mixture. Further, a soluble zirconium solution (30 weight-% ZrO₂) was added as a binder to the mixture comprising water and Cu-CHA. The pH was adjusted to 7. The final mixture solid content was 43 weight-%.

At this point, the Pd-impregnated ZrO₂ mixture was mixed into the Cu-CHA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated over its entire substrate axial length (3 inches) once from the inlet end of the substrate towards the outlet end of the substrate and once from the outlet end of the substrate towards the inlet end of the substrate, achieving the targeted inlet washcoat loading of 2.4 g/in³. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 2.05 g/in³ Cu-CHA, 0.24 g/in³ of zirconia/HfO₃/La₂O₃, 0.1 g/in³ of zirconia (binder) and a Pd loading of 15 g/ft³.

### Reference Example 6: Preparation of a Multifunctional Catalyst not According to the Present Invention

### Coating:

### Bottom Coat:

To a Si-doped titania powder (10 wt. % SiO₂, BET specific surface area of 200 m²/g, a Dv90 of 20 micrometers) was added a platinum ammine solution. After calcination at 590° C. the final Pt/Si-titania had a Pt content of 0.46 weight-% based on the weight of Si-titania. This material was added to water and the slurry was milled until the resulting Dv90 was 10 micrometers, as described in Reference Example 1. To an aqueous slurry of Cu-CHA zeolitic material (5.1 weight-% CuO and a SiO₂:Al₂O₃ molar ratio of 18:1) was added a zirconyl-acetate mixture to achieve 5 weight-% ZrO₂ after calcination based on the weight of the zeolitic material. To this Cu-CHA slurry, the Pt-containing slurry was added and stirred, creating the final slurry. The final slurry was then disposed over the full length of an uncoated honeycomb flow-through cordierite monolith substrate (diameter: 26.67 cm (10.5 inches)×length: 7.62 cm (3 inches) cylindrically shaped substrate with 400/(2.54)² cells per square centimeter and 0.1 millimeter (4 mil) wall thickness), from the inlet side of the substrate towards the outlet side, using the coating method described in Reference Example 4, forming the bottom coat. Afterwards, the coated substrate was dried at 90° C. for about 30 minutes and calcined at 590° C. for about 30 minutes. The loading of the bottom coat, after calcination was about 2 g/in³ with a Cu-CHA loading of 1.67 g/in³, a ZrO₂ loading of 0.08 g/in³, a Si-titania loading of 0.25 g/in³ and a PGM loading of 2.5 g/ft³.

### Top Coat:

To an aqueous slurry of Cu-CHA zeolitic material (5.1 weight-% CuO based on the weight of Cu-CHA and a SiO₂:Al₂O₃ molar ratio of 18:1) was added a zirconyl-acetate solution to achieve 5 weight-% ZrO₂ after calcination based on the weight of the zeolitic material. The slurry was then disposed over the full length of the honeycomb cordierite monolith substrate, coated with the first coating, from the inlet side of the substrate towards the outlet side and covering the first coating using the coating method described in Reference Example 4. Afterwards, the coated substrate was dried and calcined. The loading of the top coat after calcination was 2.0 g/in³. The final catalytic loading (bottom+top coats) in the catalyst after calcination was about 2.5 g/in³.

### Example 1: Preparation of a Multifunctional Catalyst According to the Present Invention

### Coating:

### Outlet Coat:

An incipient wetness impregnation of Pd onto a zirconium based oxidic support (88 weight-% of ZrO₂ with 10 weight-% La₂O₃ and 2 weight-% HfO₂, having a BET specific surface area of 67 m²/g, a Dv50 of 3 micrometers and a Dv90 of 16 micrometers) was conducted. Firstly, the available pore volume of the non-zeolitic oxidic support was determined and, based on this value, a diluted palladium salt solution with a volume equal to the available pore volume was made. The diluted solution was then added dropwise to the Zr-based oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the Pd-impregnated ZrO₂ mixture had a Dv90 of 10 micrometers. Separately, a Cu-CHA zeolitic material (Cu: 3.25 weight-%, calculated as CuO, based on the weight of the Cu-CHA, CHA having a Dv90 of 25 micrometers, a SiO₂:Al₂O₃ molar ratio of 31:1, and a BET specific surface area of about 625 m²/g) was added to deionized water, forming a mixture. Further, a soluble zirconium solution (30 weight-% ZrO₂) was added as a binder to the mixture comprising water and Cu-CHA. The pH was adjusted to 7. The final mixture solid content was 43 weight-%.

At this point, the Pd-impregnated ZrO₂ mixture was mixed into the Cu-CHA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated over 50% of the substrate axial length (1.5 inches) from the outlet end of the substrate towards the inlet end of the substrate, achieving the targeted inlet washcoat loading of 2.4 g/in³. To dry a coated substrate, the substrate was placed in an oven at 90° ° C. for about 30 minutes. After drying, the coated substrate was calcined for 30 minutes at 590° C. The final loading of the outlet coat in the catalyst after calcination was of 2.4 g/in³, including 2.05 g/in³ Cu-CHA, 0.24 g/in³ of zirconia/HfO₃/La₂O₃, 0.1 g/in³ of zirconia (binder) and a Pd loading of 15 g/ft³.

### Inlet Coat:

Separately, an incipient wetness impregnation of Pd onto a zeolitic material of BEA structure type ion-exchanged with iron (Fe-BEA: 4.5 wt.-% Fe, calculated as Fe₂O₃, based on the weight of Fe-BEA, BEA having a BET specific surface area of 600 m²/g, and a SiO₂:Al₂O₃ molar ratio of 10:1) was conducted. Firstly, the available pore volume of the zeolite was determined and, based on this value, a diluted palladium salt solution with a volume equal to the available pore volume was made. The diluted solution was then added dropwise to the Fe-BEA zeolite support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the mixture was milled until the particles of the mixture had a Dv90 of 10 micrometers. The mixture was then disposed over 50% of the axial length of the substrate coated with the first coating (1.5 inches) from the inlet end of the substrate towards the outlet end of the substrate using the coating method described in Reference Example 4. Afterwards, the coated substrate was dried and calcined as the first coating. The loading of the inlet coat after calcination was 1.575 g/in³. The final loading of the inlet coat in the catalyst after calcination was of 1.575 g/in³, including 1.43 g/in³ of Fe-BEA, 0.15 g/in³ of zirconia (binder) and a Pd loading of 30 g/ft³.

The total final catalytic loading in the catalyst (inlet+outlet coats) was of 1.99 g/in³ with a total Pd loading of 22.5 g/ft³.

### Example 2: Preparation of a Multifunctional Catalyst According to the Present Invention

An incipient wetness impregnation of Pd onto an aluminium oxide (having a BET specific surface area of 200 m²/g, a Dv50 of 3 micrometers and a Dv90 of 16 micrometers) was conducted. Firstly, the available pore volume of the non-zeolitic oxidic support was determined and, based on this value, a diluted palladium salt solution with a volume equal to the available pore volume was made. The diluted solution was then added dropwise to the aluminium oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers.

Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) and an Fe (3.5 weight-%, calculated as Fe₂O₃) ion-exchanged MFI zeolitic material (having a BET specific surface area of 375 m²/g, and a SiO₂:Al₂O₃ molar ratio of 27.5:1) were added to deionized water at a weight ratio of about 9:1, forming a mixture. Further, a soluble zirconium solution (30 weight-% ZrO₂) was added as a binder to the mixture comprising water, Fe-MFI and Cu-CHA. The pH was adjusted to 7. The final mixture solid content was 38 weight-%.

At this point, the Pd-impregnated Al₂O₃ mixture was mixed into the Cu-CHA/Fe-MFI mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in Reference Example 4. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 1.8 g/in³ Cu-CHA, 0.25 g/in³ Fe-MFI, 0.25 g/in³ of Al₂O₃, 0.1 g/in³ of zirconia (binder) and a Pd loading of 15 g/ft³.

### Example 3: Preparation of a Multifunctional Catalyst According to the Present Invention

An incipient wetness impregnation of Pd onto an aluminium oxide (having a BET specific surface area of 200 m²/g, a Dv50 of 3 micrometers and a Dv90 of 16 micrometers) was conducted. Firstly, the available pore volume of the non-zeolitic oxidic support was determined and, based on this value, a diluted palladium salt solution with a volume equal to the available pore volume was made. The diluted solution was then added dropwise to the aluminium oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers.

Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) and Zeolite Y (FAU framework type) ion-exchanged with rare earth (RE) metals (RE (with predominantly La and Ce): about 16 weight-%, calculated as Re₂O₃, based on the weight of the RE-Y, zeolite Y having a BET specific surface area of 700 m²/g, and a SiO₂:Al₂O₃ molar ratio of 5:1) were added to deionized water at a weight ratio of about 7:1, forming a mixture. Further, a soluble zirconium solution (30 weight-% ZrO₂) was added as a binder to the mixture comprising water, RE-Zeolite Y and Cu-CHA. The pH was adjusted to 7. The final mixture solid content was 38 weight-%.

At this point, the Pd-impregnated Al₂O₃ mixture was mixed into the Cu-CHA/RE-Zeolite Y mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in General coating method. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 1.8 g/in³ Cu-CHA, 0.25 g/in³ RE-zeolite Y, 0.25 g/in³ of Al₂O₃, 0.1 g/in³ of zirconia (binder) and a Pd loading of 15 g/ft³.

### Example 4: Preparation of an Exhaust Gas Treatment System According to the Present Invention

An exhaust gas treatment system according to the present invention was prepared by combining the catalyst of Example 1 (Catalyst 1) and the catalyst of Reference Example 6 (Catalyst 2), wherein the catalyst of Reference Example 6 was located downstream of the catalyst of Example 1.

### Comparative Example 1: Preparation of an Exhaust Gas Treatment System not According to the Present Invention

An exhaust gas treatment system not according to the present invention was prepared by combining the catalyst of Reference Example 5 (Catalyst 1) and the catalyst of Reference Example 6 (Catalyst 2), wherein the catalyst of Reference Example 6 was located downstream of the catalyst of Reference Example 5.

### Example 5 Testing of the Exhaust Gas Treatment Systems of Example 4 and of Comparative Example 1

Steady state points were run to test two different systems in HC oxidation capability. Test per-formed downstream a Heavy Duty Diesel engine. Test conditions are illustrated in FIGS. 1-3. Catalyst 1 inlet temperatures were 305, 325 and 350° C. with a targeted catalyst out temperature of 450° C. Temperatures downstream of Catalyst 1 as well as of Catalyst 2 were measured for the two systems. The results are shown in FIGS. 4 and 6 (Comparative Example 1) and FIGS. 5 and 7 (Inventive Example 4).

As may be taken from FIGS. 4 and 5, the targeted catalyst out temperature of 450° C. is only attained with the system according to the present invention which permits to achieve higher exotherms compared to the comparative systems. Further, as to FIGS. 6 and 7, which show the HC slip at the outlet end of Catalyst 1 and Catalyst 2 of the tested systems, it is noted that the HC slip is very low for the inventive system when the full exotherm is achieved (450° C.).

### Example 6: Preparation of a Multifunctional Catalyst According to the Present Invention

An incipient wetness impregnation of Pd onto a zeolitic material having a framework type FER in the ammonium-form, having a BET specific surface area of 400 m²/g, and a SiO₂:Al₂O₃ of 20:1. Firstly, the available pore volume of the zeolite was determined and, based on this value, a diluted palladium salt solution with a volume equal to the available pore volume was made. The diluted solution was then added dropwise to the FER zeolitic material support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers. Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) was added to deionized water, forming a mixture. Further, a soluble zirconium solution (30 weight-% ZrO₂) was added as a binder to the mixture comprising water and Cu-CHA. The pH was adjusted to 7. The final mixture solid content was 38 weight-%.

At this point, the Pd-impregnated FER mixture was mixed into the Cu-CHA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in Reference Example 4. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 2.05 g/in³ Cu-CHA, 0.25 g/in³ of FER, 0.1 g/in³ of zirconia (binder) and a Pd loading of 15 g/ft³.

### Example 7: Preparation of a Multifunctional Catalyst According to the Present Invention

An incipient wetness impregnation of Pd onto a zeolitic material having a framework type BEA ion-exchanged with iron (Fe: 4.5 weight %, calculated as Fe₂O₃, based on the weight of the Fe-BEA), having a BET specific surface area of 600 m²/g, and a SiO₂:Al₂O₃ molar ratio of 10:1). Firstly, the available pore volume of the zeolite was determined and, based on this value, a diluted palladium salt solution with a volume equal to the available pore volume was made. The diluted solution was then added dropwise to the Fe-BEA zeolite support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers. Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) was added to deionized water, forming a mixture. Further, a soluble zirconium solution (30 weight-% ZrO₂) was added as a binder to the mixture comprising water and Cu-CHA. The pH was adjusted to 7. The final mixture solid content was 38 weight-%.

At this point, the Pd-impregnated Fe-BEA mixture was mixed into the Cu-CHA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in Reference Example 4. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 2.05 g/in³ Cu-CHA, 0.25 g/in³ of Fe-BEA, 0.1 g/in³ of zirconia (binder) and a Pd loading of 15 g/ft³.

### Example 8: Preparation of a Multifunctional Catalyst According to the Present Invention

An incipient wetness impregnation of Pd onto an aluminium oxide, having a BET specific surface area of 200 m²/g, a Dv50 of 3 micrometers and a Dv90 of 16 micrometers. Firstly, the available pore volume of the non-zeolitic oxidic support was determined and, based on this value, a diluted palladium salt solution with a volume equal to the available pore volume was made. The diluted solution was then added dropwise to the aluminium oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers.

Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) and a Fe-BEA zeolitic material (Fe: 4.5 weight-%, calculated as Fe₂O₃, based on the weight of the Fe-BEA, BEA having a BET specific surface area of 600 m²/g, and a SiO₂:Al₂O₃ molar ratio of 10:1) were added to deionized water at a weight ratio of about 9:1, forming a mixture. Further, a soluble zirconium solution (30 weight-% ZrO₂) was added as a binder to the mixture comprising water, Fe-BEA and Cu-CHA. The pH was adjusted to 7. The final mixture solid content was 38 weight-%.

At this point, the Pd-impregnated Al₂O₃ mixture was mixed into the Cu-CHA/Fe-BEA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in Reference Example 4. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 1.8 g/in³ Cu-CHA, 0.25 g/in³ Fe-BEA, 0.25 g/in³ of Al₂O₃, 0.1 g/in³ of zirconia (binder) and a Pd loading of 15 g/ft³.

### Example 9: Preparation of a Multifunctional Catalyst According to the Present Invention

The catalyst of Example 9 was prepared as the catalyst of Example 8 except that alumina oxidic support was replaced by a zirconium oxidic support (88 weight-% of ZrO₂ with 10 weight-% La₂O₃ and 2 weight-% HfO₂, having a BET specific surface area of 67 m²/g, a Dv50 of 3 micrometers and a Dv90 of 16 micrometers). The final loading of the coating in the catalyst after calcination was of 2.4 g/in³, including 1.8 g/in³ Cu-CHA, 0.25 g/in³ Fe-BEA, 0.25 g/in³ of zirconia/HfO₃/La₂O₃, 0.1 g/in³ of zirconia (binder) and a Pd loading of 15 g/ft³.

### Example 10: Preparation of a Multifunctional Catalyst According to the Present Invention

An incipient wetness impregnation of Pd onto an aluminium oxide, having a BET specific surface area of 200 m²/g, a Dv50 of 3 micrometers and a Dv90 of 16 micrometers. Firstly, the available pore volume of the non-zeolitic oxidic support was determined and, based on this value, a diluted palladium salt solution with a volume equal to the available pore volume was made. The diluted solution was then added dropwise to the aluminium oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers.

Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) and an FER zeolitic material in the ammonium-form (having a BET specific surface area of 400 m²/g, and a SiO₂:Al₂O₃ molar ratio of 20:1) were added to deionized water at a weight ratio of about 9:1, forming a mixture. Further, a soluble zirconium solution (30 weight-% ZrO₂) was added as a binder to the mixture comprising water, FER and Cu-CHA. The pH was adjusted to 7. The final mixture solid content was 38 weight-%.

At this point, the Pd-impregnated Al₂O₃ mixture was mixed into the Cu-CHA/FER mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in General coating method. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 1.8 g/in³ Cu-CHA, 0.25 g/in³ FER, 0.25 g/in³ of Al₂O₃, 0.1 g/in³ of zirconia (binder) and a Pd loading of 15 g/ft³.

### Example 11: Preparation of a Multifunctional Catalyst According to the Present Invention

### Coating:

### Outlet Coat:

The outlet coat of Example 11 was prepared as the outlet coat of Example 11, except that zirconium based oxidic support was replaced by aluminium oxide, having a BET specific surface area of 200 m²/g, a Dv50 of 3 micrometers and a Dv90 of 16 micrometers. The final loading of the outlet coat in the catalyst after calcination was of 2.4 g/in³, including 2.05 g/in³ Cu-CHA, 0.24 g/in³ of Al₂O₃, 0.1 g/in³ of zirconia (binder) and a Pd loading of 15 g/ft³.

### Inlet Coat:

An incipient wetness impregnation of Pd onto an aluminium oxide, having a BET specific surface area of 200 m²/g, a Dv50 of 3 micrometers and a Dv90 of 16 micrometers. Firstly, the available pore volume of the oxidic support was determined and, based on this value, a diluted palladium salt solution with a volume equal to the available pore volume was made. The diluted solution was then added dropwise to the aluminium oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers.

Separately, a BEA zeolitic material, ion-exchanged with iron (4.5 weight-% of Fe, calculated as Fe₂O₃, based on the weight of Fe-BEA, BEA having a BET specific surface area of 600 m²/g, and a SiO₂:Al₂O₃ molar ratio of 10:1) was added to deionized water. Further, a soluble zirconium solution (30 weight-% ZrO₂) was added as a binder to the mixture comprising water and Fe-BEA. The pH was adjusted to 7. The final mixture solid content was 38 weight-%.

At this point, the Pd-impregnated Al₂O₃ mixture was mixed into the Fe-BEA mixture and the pH was again adjusted to 7. The final mixture was ready for disposal on a honeycomb flow-through monolith cordierite substrate. The final loading of the inlet coat in the catalyst after calcination was 2.4 g/in³, including 2.05 g/in³ Fe-BEA, 0.25 g/in³ of Al₂O₃, 0.1 g/in³ of zirconia (binder) and a Pd loading of 15 g/ft³.

### Example 12: Preparation of a Multifunctional Catalyst According to the Present Invention

An incipient wetness impregnation of Pd onto a zeolitic material having a framework type BEA in its H-form having a BET specific surface area of 600 m²/g, and a SiO₂:Al₂O₃ of 800:1. Firstly, the available pore volume of the zeolite was determined and, based on this value, a diluted palladium salt solution with a volume equal to the available pore volume was made. The diluted solution was then added dropwise to the BEA zeolite support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers. Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5:1, and a BET specific surface area of about 625 m²/g) was added to deionized water, forming a mixture. Further, a soluble zirconium solution (30 weight-% ZrO₂) was added as a binder to the mixture comprising water and Cu-CHA. The pH was adjusted to 7. The final mixture solid content was 38 weight-%.

At this point, the Pd-impregnated BEA mixture was mixed into the Cu-CHA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in General coating method. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 2.05 g/in³ Cu-CHA, 0.25 g/in³ of BEA, 0.1 g/in³ of zirconia (binder) and a Pd loading of 15 g/ft³.

### Example 13: Preparation of a Multifunctional Catalyst According to the Present Invention

An incipient wetness impregnation of Pd onto an aluminium oxide, having a BET specific surface area of 200 m²/g, a Dv50 of 3 micrometers and a Dv90 of 16 micrometers). Firstly, the available pore volume of the oxidic support was determined and, based on this value, a diluted palladium salt solution with a volume equal to the available pore volume was made. The diluted solution was then added dropwise to the aluminium oxidic support over 30 minutes under constant stirring resulting in a moist material. The resulting material was then calcined in an oven at 590° C. and allowed to cool. After calcination, the resulting powder was mixed with distilled water to form an aqueous mixture with 40% solids and the pH was adjusted to 3.75 using an organic acid. At this point, the slurry was milled until the particles of the mixture had a Dv90 of 10 micrometers. Separately, a Cu-CHA zeolitic material (Cu: 5.1 weight-%, calculated as CuO, based on the weight of the Cu-CHA, CHA having a Dv90 of 25 micrometers, a SiO₂:Al₂O₃ molar ratio of 18.5, and a BET specific surface area of about 625 m²/g) and a BEA zeolitic material in the H-form having a BET specific surface area of 600 m²/g, and a SiO₂:Al₂O₃ of 800:1 were added to deionized water at a weight ratio of about 9:1, forming a mixture. Further, a soluble zirconium solution (30 weight-% ZrO₂) was added as a binder to the mixture comprising water, BEA and Cu-CHA. The pH was adjusted to 7. The final mixture solid content was 38 weight-%.

At this point, the Pd-impregnated Al₂O₃ mixture was mixed into the Cu-CHA/BEA mixture and the pH was again adjusted to 7. The final mixture was ready for disposal on a honeycomb flow-through monolith cordierite substrate (diameter: 26.67 cm (10.5 inches)×length: 7.62 cm (3 inches) cylindrically shaped substrate with 400/(2.54)² cells per square centimeter and 0.10 millimeter (4 mil) wall thickness). The substrate was coated with the final mixture according to the coating method defined in General coating method. To achieve the targeted washcoat loading of 2.4 g/in³, the substrate was coated once along its entire length, from the outlet end of the substrate to the inlet end, with a drying and calcination steps after the coating step. To dry a coated substrate, the substrate was placed in an oven at 90° C. for about 30 minutes. After drying, the coated substrate was calcined for 30 minutes at 590° C. The final loading of the coating in the catalyst after calcination was of 2.4 g/in³, including 1.8 g/in³ Cu-CHA, 0.25 g/in³ BEA, 0.25 g/in³ of Al₂O₃, 0.1 g/in³ of zirconia (binder) and a Pd loading of 15 g/ft³.

### Example 14: Preparation of a Multifunctional Catalyst According to the Present Invention

The catalyst of Example 14 was prepared as the catalyst of Example 10, except that palladium was replaced by platinum. The final loading of the coating in the catalyst after calcination was of 2.4 g/in³, including 1.8 g/in³ Cu-CHA, 0.25 g/in³ FER, 0.25 g/in³ of Al₂O₃, 0.1 g/in³ of zirconia (binder) and a Pt loading of 15 g/ft³.

### Example 15: Preparation of a Multifunctional Catalyst According to the Present Invention

### First (Bottom) Coating:

To a Si-doped titania powder (10 wt % SiO₂, BET specific surface area of 200 m²/g, a Dv90 of 20 micrometers) was added a platinum ammine solution. After calcination at 590° C. the final Pt/Si-titania had a Pt content of 0.46 weight-% based on the weight of Si-titania. This material was added to water and the slurry was milled until the resulting Dv90 was 10 micrometers. To an aqueous slurry of Cu-CHA zeolitic material (Cu: 5.1 weight-%, calculated as CuO, based on the weight of the Cu-CHA, CHA having a SiO₂:Al₂O₃ molar ratio of 18:1) was added a zirconyl-acetate solution to achieve 5 weight-% ZrO₂ after calcination based on the weight of the zeolitic material. To this Cu-CHA slurry, the Pt-containing slurry was added and stirred, creating the final slurry. The final slurry was then disposed over 50% of the substrate's axial length, from the outlet end towards the inlet end of an uncoated honeycomb flow-through cordierite monolith substrate (diameter: 26.67 cm (10.5 inches)×length: 7.62 cm (3 inches) cylindrically shaped substrate with 400/(2.54)² cells per square centimeter and 0.1 millimeter (4 mil) wall thickness). Afterwards, the substrate was dried at 120° C. for 10 minutes and at 160° C. for 30 minutes and was then calcined at 450° C. for 30 minutes. The loading of the first coating, after calcination was about 0.5 g/in³ with a Cu-CHA loading of 0.25 g/in³, a ZrO₂ loading of 0.04 g/in³, a Si-titania loading of 0.21 g/in³ and a Pt loading of 5 g/ft³.

### Second (Top) Coating:

The slurry for preparing the second coating was prepared as the slurry for preparing the coating of Example 10. The slurry was then disposed from the outlet end toward the inlet end of the substrate coated with the first coating over the entire length of the substrate according to the General coating method (Ref. Ex. 4). To achieve the targeted washcoat loading of 2.4 g/in³, the substrate was coated once along its entire length, from the outlet end of the substrate to the inlet end, with drying and calcination steps after the coating step. To dry a coated substrate, the substrate was placed in an oven at 90° C. for about 30 minutes. After drying, the coated substrate was calcined for 30 minutes at 590° C. The final loading of the second (top) coating in the catalyst after calcination was of 2.4 g/in³, including 1.8 g/in³ Cu-CHA, 0.25 g/in³ FER, 0.25 g/in³ of Al₂O₃, 0.1 g/in³ of zirconia (binder) and a Pd loading of 15 g/ft³.

### Example 16: Testing of the Multifunctional Catalysts of Examples 10 and 12-15—DeNOx, N₂O Formation and NH₃ Slip

The testing of the fresh catalysts was done on a heavy-duty diesel engine under steady state conditions. The DeNOx, N₂O formation as well as ammonia slip were measured under different conditions:
at 200° ° C. at an exhaust flow of about 250 kg/h; with NOx about 1000 ppm (the measurements were done after 20 min the time for stabilizing—the average reported in the FIG. was calculated over the final 2 minutes after stabilization);
at 350° C. at an exhaust flow of about 250 kg/h; with NOx about 1800 ppm (the measurements were done after 20 min the time for stabilizing—the average reported in the FIG. was calculated over the final 2 minutes after stabilization).

The results are reported in FIGS. 8-10.

Comments on Examples 10, 12 and 13 (Pd-only): As may be taken from FIGS. 8 and 9, all the Pd-based multifunction catalysts (MFCs) show comparable DeNOx both at low and high temperatures. The MFCs that contain a zeolite with a high Si/Al ratio (Examples 12 and 13) display higher N₂O make than the MFC of Example 10.

### Comments on Examples 14 and 15 (Pt-Containing):

As may be taken from FIGS. 9 and 10, when Pt is included in the MFC instead of Pd (Example 14), the MFC displays lower DeNOx at high temperature (due to NH₃ oxidation, which predominantly happens at higher temperature) and consequently low NH₃ slip. In parallel, the MFC with Pt-only also displays higher N₂O make. Further, as may be taken from FIGS. 8-10, when a PGM-containing bottom coat (=AMOX) is included in the MFC (Example 15), the high temperature DeNOx does not suffer when compared to Example 14, while showing equal low temperature DeNOx to all other MFCs. Concurrently, the NH₃ slip is low, namely of less than 10 ppm while also displaying a significantly lower N₂O formation than Example 14. It is noted that without wanting to be bound to any theory, Low temperature NH₃ slip is predominantly affected by storage effects as Pt is not active at 200° ° C. for NH₃ oxidation.

### BRIEF DESCRIPTION OF THE FIGURES

FIGS. 1 to 3 show the testing conditions of the two exhaust gas treatment systems.

FIGS. 4 and 6 show the different temperatures obtained at the outlet end of Catalyst 1 and Catalyst 2 of the comparative system as well as the HC slip at the outlet end of Catalyst 1 and Catalyst 2, when applying Catalyst 1 inlet temperatures of 305, 325 and 350° C.

FIGS. 5 and 7 show the different temperatures obtained at the outlet end of Catalyst 1 and Catalyst 2 of the inventive system as well as the HC slip at the outlet end of Catalyst 1 and Catalyst 2, when applying Catalyst 1 inlet temperatures of 305, 325 and 350° C.

FIG. 8 shows the DeNOx measured for the catalysts of Examples 10 and 12-15 at low and high temperatures.

FIG. 9 show the N₂O formation measured for the catalysts of Examples 10 and 12-15 at low and high temperatures.

FIG. 10 show the NH₃ slip measured for the catalysts of Examples 10 and 12-15 at low and high temperatures.

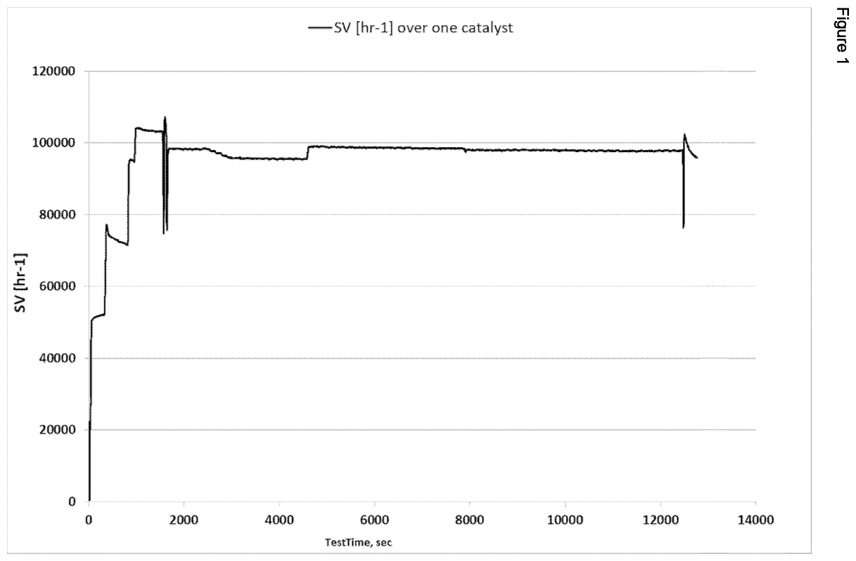

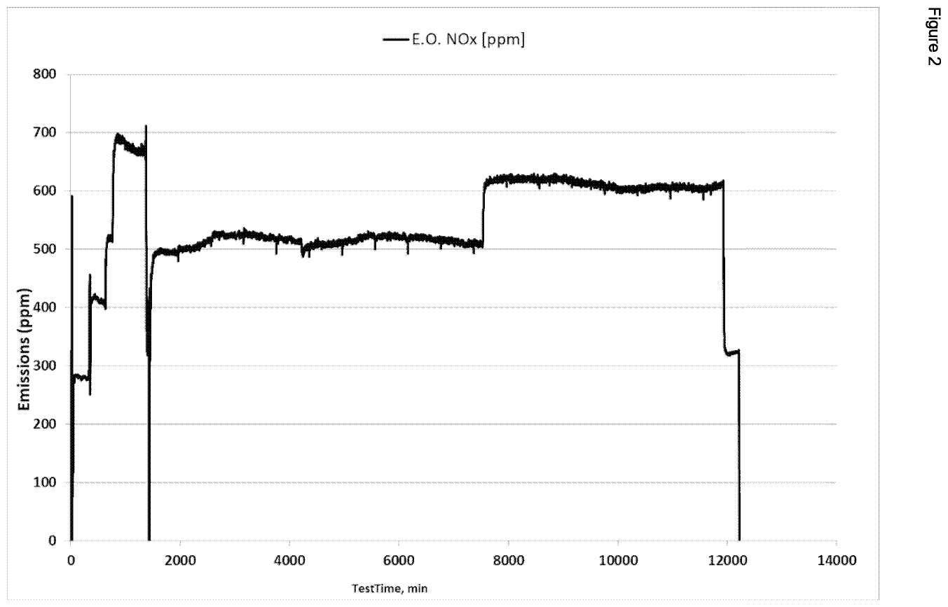

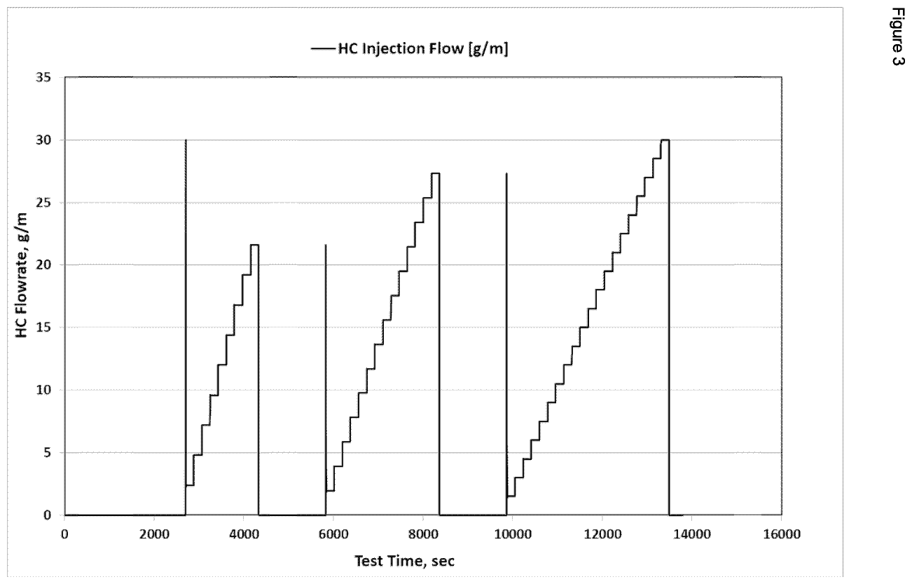

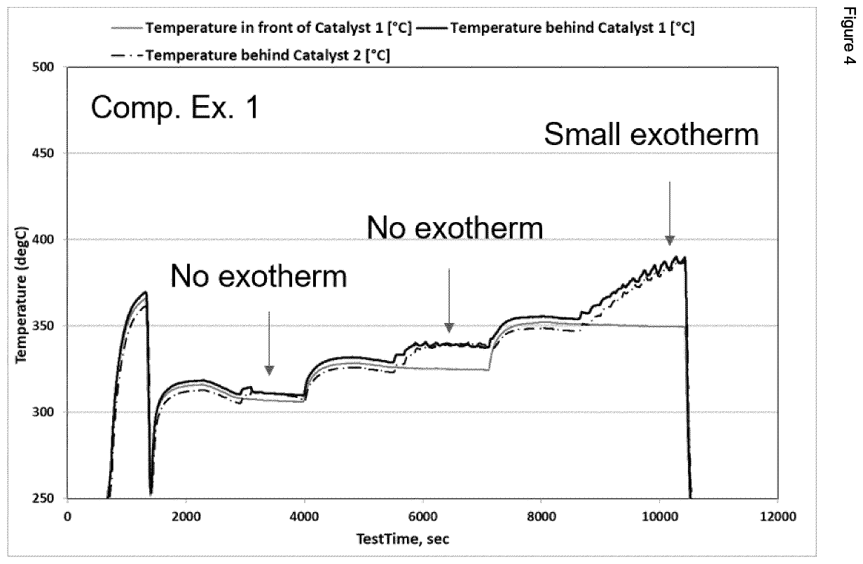

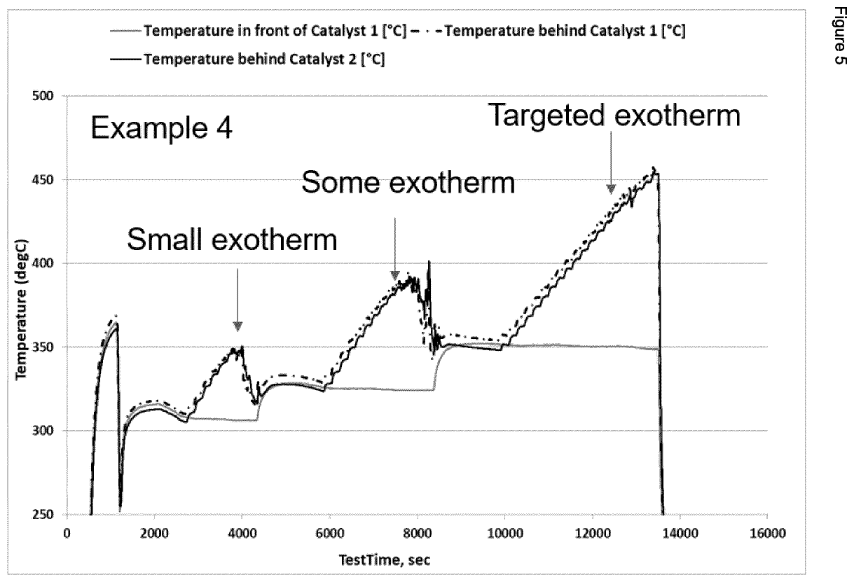

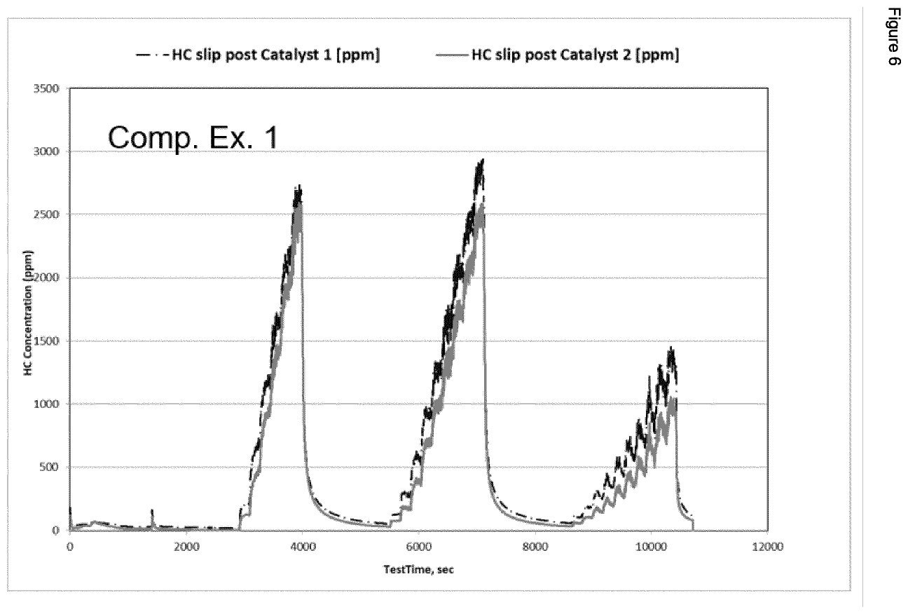

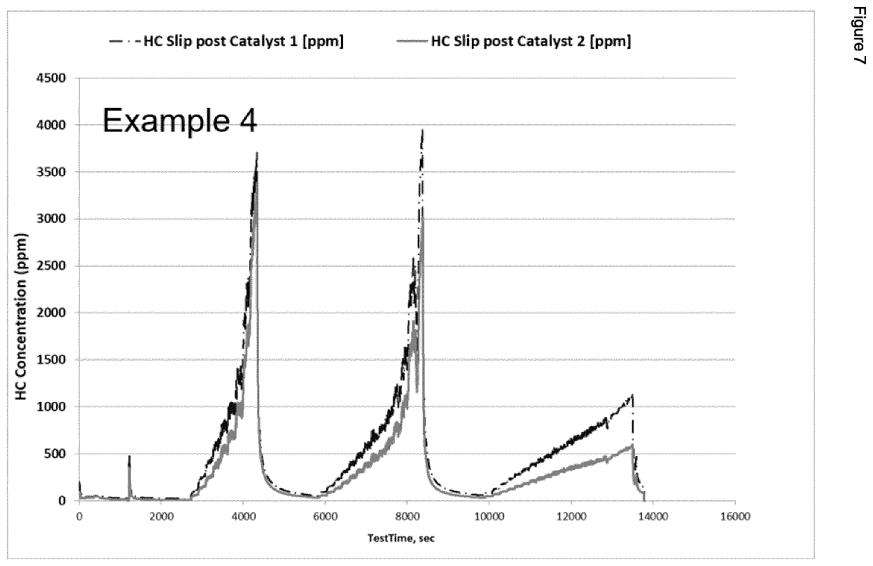

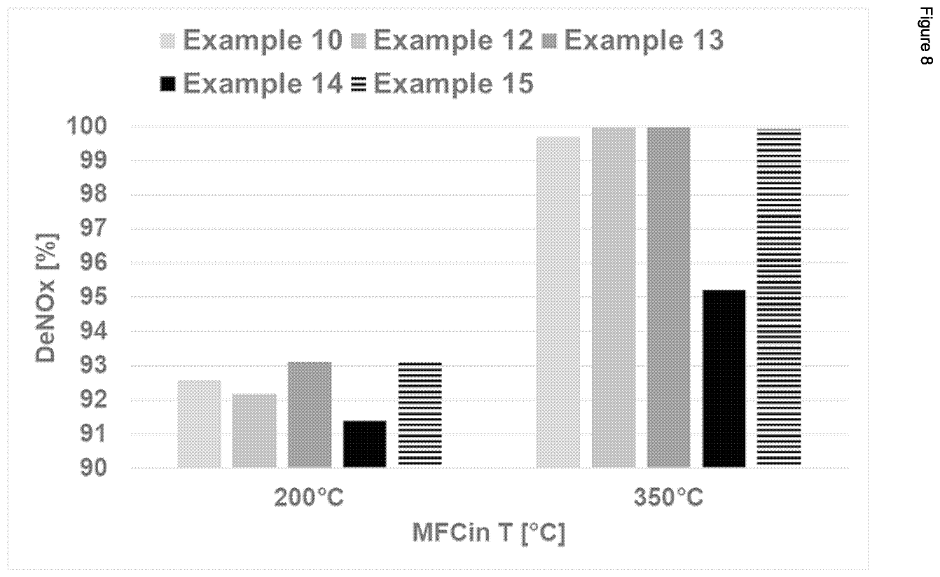

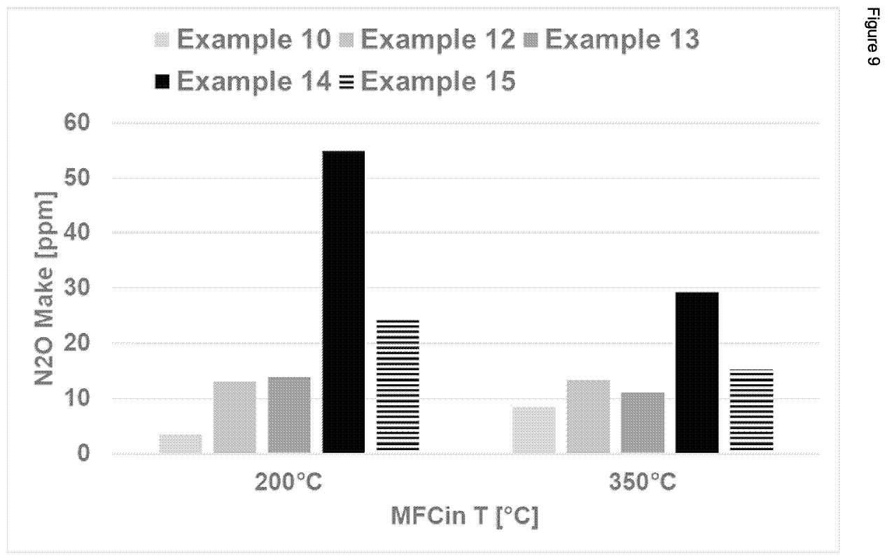

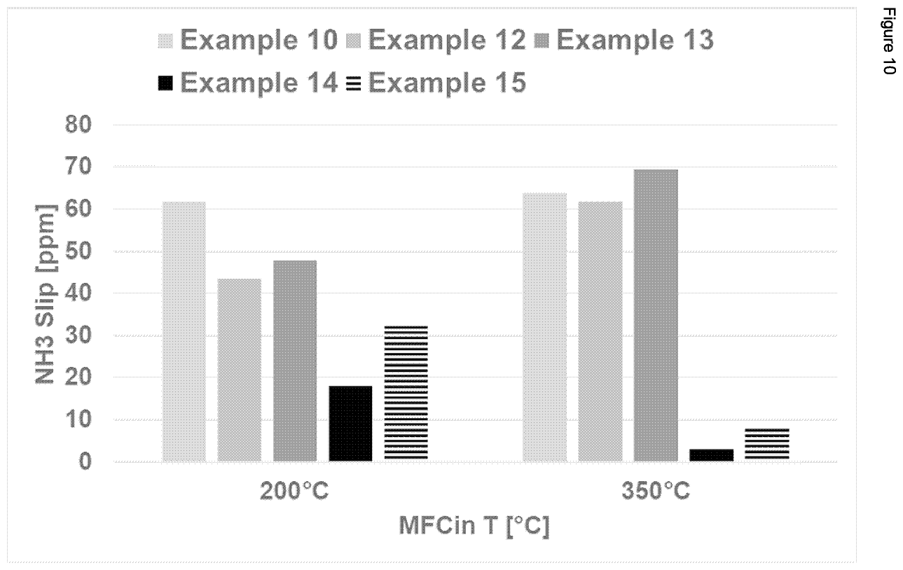

### CITED LITERATURE

WO 2018/224651 A2
U.S. Pat. No. 10,589,261 B2
U.S. Pat. No. 5,788,834 B

1. A catalyst for the selective catalytic reduction of NOx and for the cracking and conversion of a hydrocarbon, comprising
(i) a substrate comprising an inlet end, an outlet end, a substrate axial length extending from the inlet end to the outlet end and a plurality of passages defined by internal walls of the substrate extending therethrough;
(ii) a coating disposed on the surface of the internal walls of the substrate, said coating comprising a platinum group metal, an 8-membered ring pore zeolitic material comprising one or more of copper and iron, and further comprising a 10- or more membered ring pore zeolitic material.

2. The catalyst of claim 1, wherein the coating (ii) further comprises a non-zeolitic oxidic material comprising one or more of alumina, zirconia, silica, titania and ceria.

3. The catalyst of claim 1, wherein the 8-membered ring pore zeolitic material comprised in the coating (ii) has a framework type selected from the group consisting of CHA, AEI, RTH, LEV, DDR, KFI, ERI, AFX, a mixture of two or more thereof and a mixed type of two or more thereof, preferably selected from the group consisting of CHA, AEI, RTH, AFX, a mixture of two or more thereof and a mixed type of two or more thereof.

4. The catalyst of claim 1, wherein the 10- or more membered ring pore zeolitic material comprised in the coating (ii) is a zeolitic material having a framework type selected from the group consisting of FER, MFI, BEA, MWW, AFI, MOR, OFF, MFS, MTT, FAU, LTL, MEI, MOR, a mixture of two or more thereof and a mixed type of two or more thereof.

5. The catalyst of claim 1, wherein the platinum group metal comprised in the coating (ii) is palladium.

6. The catalyst of claim 1, wherein in the framework structure of the 10- or more membered ring pore zeolitic material comprised in the coating (ii), the molar ratio of Si to Al, calculated as molar SiO₂:Al₂O₃, is in the range of from 2:1 to 60:1.

7. The catalyst of claim 1, wherein the 10- or more membered ring pore zeolitic material comprised in the coating (ii) is a zeolitic material having a framework type BEA, and wherein in the framework structure of said zeolitic material, the molar ratio of Si to Al, calculated as molar SiO₂:Al₂O₃, is in the range of from 4:1 to 20:1; or wherein the 10- or more membered ring pore zeolitic material comprised in the coating (ii) is a zeolitic material having a framework type FER, and wherein in the framework structure of said zeolitic material, the molar ratio of Si to Al, calculated as molar SiO₂:Al₂O₃, is in the range of from 10:1 to 30:1.

8. The catalyst of claim 1, wherein the 10- or more membered ring pore zeolitic material comprised in the coating (ii) is a zeolitic material having a framework type FAU, and wherein, in the framework structure of said zeolitic material, the molar ratio of Si to Al, calculated as molar SiO₂:Al₂O₃, is in the range of from 3:1 to 15:1; or wherein the 10- or more membered ring pore zeolitic material comprised in the coating (ii) is a zeolitic material having a framework type MFI, and wherein in the framework structure of said zeolitic material, the molar ratio of Si to Al, calculated as molar SiO₂:Al₂O₃, is in the range of from 10:1 to 35:1.

9. The catalyst of claim 1, wherein the 10- or more membered ring pore zeolitic material comprised in the coating (ii) comprises one or more of iron, copper and a rare earth element component.

10. The catalyst of claim 1, wherein the coating according to (ii) comprises
(ii.1) an inlet coat comprising the platinum group metal and the 10- or more membered ring pore zeolitic material; and
(ii.2) an outlet coat comprising the platinum group metal, a non-zeolitic oxidic material, and the 8-membered ring pore zeolitic material comprising one or more of copper and iron;
wherein the inlet coat (ii.1) extends over x % of the substrate axial length from the inlet end towards the outlet end of the substrate according to (i), wherein x ranges from 20 to 80, and
wherein the outlet coat (ii.2) extends over y % of the substrate axial length from the outlet end towards the inlet end of the substrate according to (i), wherein y ranges from 20 to 80.

11. The catalyst of claim 10, wherein the platinum group metal in the inlet coat (ii.1) is palladium and the 10- or more membered ring pore zeolitic material in the inlet coat (ii.1) is a zeolitic material having a framework type BEA; or
wherein the platinum group metal in the inlet coat (ii.1) is palladium and the 10- or more membered ring pore zeolitic material in the inlet coat (ii.1) is a zeolitic material having a framework type FAU; or
wherein the platinum group metal of the inlet coat (ii.1) is palladium and the 10- or more membered ring pore zeolitic material in the inlet coat (ii.1) is a zeolitic material having a framework type MFI.

12. The catalyst of claim 10, wherein in the framework structure of the 8-membered ring pore zeolitic material of the outlet coat (ii.2), the molar ratio of Si to Al, calculated as molar SiO2:Al2O3, is in the range of from 15:1 to 33:1.

13. The catalyst of claim 1, wherein the coating (ii) is a single coat.

14. The catalyst of claim 13, wherein in the framework structure of the 8-membered ring pore zeolitic material of the coating (ii), the molar ratio of Si to Al, calculated as molar SiO2:Al₂O₃, is in the range of from 15:1 to 20:1.

15. The catalyst of claim 13, wherein the weight ratio of the 8-membered ring pore zeolitic material of the coating (ii) relative to the 10- or more membered ring pore zeolitic material of the coating (ii) is in the range of from 2:1 to 15:1.

16. The catalyst of claim 13, wherein the 8-membered ring pore zeolitic material of the coating (ii) has a framework type CHA and the 10- or more membered ring pore zeolitic material of the coating (ii) has a framework type BEA and comprises iron;
or
wherein the 8-membered ring pore zeolitic material of the coating (ii) has a framework type CHA and the 10- or more membered ring pore zeolitic material of the coating (ii) has a framework type FAU and comprises a rare earth element component.

17. The catalyst of claim 14, wherein the 8-membered ring pore zeolitic material of the coating (ii) has a framework type CHA and the 10- or more membered ring pore zeolitic material of the coating (ii) has a framework type MFI and comprises iron;
or
wherein the 8-membered ring pore zeolitic material of the coating (ii) has a framework type CHA and the 10- or more membered ring pore zeolitic material of the coating (ii) has a framework type FER.

18. (canceled)

19. An exhaust gas treatment system for treating an exhaust gas stream exiting a diesel engine, said exhaust gas treatment system having an upstream end for introducing said exhaust gas stream into said exhaust gas treatment system, wherein said exhaust gas treatment system comprises
(a) a first catalyst having an inlet end and an outlet end, wherein said catalyst is a catalyst according to claim 1;
(b) a second catalyst having an inlet end and an outlet end and comprising a coating disposed on a substrate, wherein the coating comprises a platinum group metal supported on a non-zeolitic oxidic material and further comprises one or more of a vanadium oxide, a tungsten oxide and a zeolitic material comprising one or more of copper and iron;
wherein the first catalyst according to (a) is the first catalyst of the exhaust gas treatment system downstream of the upstream end of the exhaust gas treatment system and wherein the inlet end of the first catalyst is arranged upstream of the outlet end of the first catalyst;
wherein in the exhaust gas treatment system, the second catalyst according to (b) is located downstream of the first catalyst according to (a) and wherein the inlet end of the second catalyst is arranged upstream of the outlet end of the second catalyst.

20. A catalyst for the selective catalytic reduction of NOx, for the cracking and conversion of a hydrocarbon, and for the oxidation of ammonia, comprising
a substrate comprising an inlet end, an outlet end, a substrate axial length extending from the inlet end to the outlet end and a plurality of passages defined by internal walls of the substrate extending therethrough;
a first coating disposed on the surface of the internal walls of the substrate, said coating comprising a platinum group metal supported on a non-zeolitic oxidic material and further comprises one or more of a vanadium oxide, a tungsten oxide and a zeolitic material comprising one or more of copper and iron;
a second coating disposed on the first coating, said coating comprising a platinum group metal, an 8-membered ring pore zeolitic material comprising one or more of copper and iron, and further comprising a 10- or more membered ring pore zeolitic material.
